(19) United States
(12) Patent Application Publication
(10) Pub. No.: US 2020/0079974 A1
(43) Pub. Date: Mar. 12, 2020

(54) FLUORINE-FREE OIL REPELLENT COATING, METHODS OF MAKING SAME, AND USES OF SAME

(71) Applicant: Cornell University, Ithaca, NY (US)

(72) Inventors: Genggeng QI, Ithaca, NY (US); Emmanuel P. GIANNELIS, Ithaca, NY (US); Jintu FAN, Ithaca, NY (US)

(21) Appl. No.: 16/606,188

(22) PCT Filed: Apr. 17, 2018
(86) PCT No.: PCT/US2018/028029

§ 371 Date: Oct. 17, 2019

Related U.S. Application Data
(60) Provisional application No. 62/486,245, filed on Apr. 17, 2017.

(51) Int. Cl. C09D 183/08; C08G 77/16; C08G 77/18; C08G 77/388; C08K 3/36; C08L 83/08; D06M 15/643

(52) U.S. Cl. CPC C09D 183/08; C08G 77/16; C08G 77/18; C08G 77/388; C08K 3/36; C08L 83/08; C08L 2312/00; C08K 2201/011; C08L 2201/22; C08L 2203/12; C08L 2203/16; C08L 2205/02; D06M 15/643

(57) ABSTRACT

Provided are fluorine-free, oleophobic layers including one more or polydimethylsiloxane resin layers. The layers can be disposed on a portion of or all of a surface of a substrate. Also provided are methods of making and using same.

### CROSS REFERENCE TO RELATED APPLICATIONS

This application claims priority to U.S. Provisional Application No. 62/486,245, filed on Apr. 17, 2017, the disclosure of which is hereby incorporated by reference.

### FIELD OF THE DISCLOSURE

The disclosure generally relates to polymer-based oleophobic coatings. More particularly, the disclosure relates to poly(dimethyl)siloxane (PDMS) resin based oleophobic coatings.

### BACKGROUND OF THE DISCLOSURE

The textile industry is under intense pressure to remove all hazardous chemicals from their products and supply chain. High on that list of chemicals is fluorine-containing compounds. Because of their resistance to both water and oil, per- and polyfluorinated substances are extremely attractive in a number of industrial applications and consumer products such as carpeting, apparels, and upholstery. Polyfluorinated compounds are resistant to degradation and persist in the environment. They bioaccumulate and some have been linked to adverse health effects at least in laboratory animals.

Finding replacements for fluorine-based compounds while maintaining the same level of performance and durability is not trivial. Oil repellent coatings are useful for several consumer products and industrial applications such as antiwetting and self-cleaning. While there are many examples of superhydrophobic coatings, limited progress has been made towards highly oleophobic coatings. Many superhydrophobic coatings turn out to be oleophilic. In addition, in contrast to the superhydrophobic state, oleophobicity could be significantly different depending on the type of oils. A superoleophobic surface (contact angle>150°) to certain oil may be oleophilic to another with lower surface tension.

A challenge in engineering oleophobic coatings stems from a fundamental limitation in materials. As typical surface tensions of hydrocarbon oils are in the range of 20-36 mN/m, the surface tension of a smooth oil repellent substrate, according to the Young's equation, must be less than 20 mN/m². Specifically, the surface energy of olive oil is ˜32 mN/m, and depending on their type, the surface energy for vegetable oils is typically in the low 30 s mN/m. Mineral oil, which is the first oil used in the AATCC® oleophobicity standard testing (Grade 1), has a surface energy of 31.5 mN/m. The requirement for low surface energy suggests that most commonly used materials are not intrinsically oleophobic. Only few fluorinated materials can meet this prerequisite for oleophobicity. Indeed, all so-called superoleophobic coatings developed to date use fluorinated compounds with abundant —CF₂— and —CF₃ groups, such as PTFE, perfluorosilanes and perfluoropolymers. Considering the material's limitation of intrinsic surface tension, essentially all previously developed highly-oleophobic coatings are based on low surface energy fluorinated materials.

Following the development of superhydrophobic materials, proper surface roughness can be introduced to enhance oleophobicity. For example, re-entrant structures have been proposed to prepare oleophobic surfaces.

TABLE 1
Summary of Previous Work for Highly Oleophobic Surfaces

| Substrate | Surface Modifier | Oil | CA (°) | Method |
|---|---|---|---|---|
| Glass | PFOTS modified | hexadecane | 140 | vapor deposition |
| | silicone nanofilament | | | |
| Polyester fabric | fluorodecyl POSS, | decane | 149 | dip coating |
| | Tecnoflon BR9151 | | | |
| polypropylene | PTFE | hexadecane | 140 | plasma etching |
| Silicon wafer, | fluoroPOSS, PFODS | octane | 163 | lithography, electrospinning |
| PMMA fiber | | | | |
| PEMA coated | fluorodecyl POSS, | rapeseed oil | ~80 | dip coating |
| mesh | Tecnoflon | | | |
| Copper foils | 1H,1H,2H,2H-perfluorodecanethiol | hexadecane | ~161 | dip coating |
| PS/PMMA | C4F8 plasma | hexadecane | 101 | lithography, plasma etching |
| film | | | | |
| Silicon wafer | PFOTS | hexadecane | 151 | plasma etching |
| Cotton fabric | PFDDE, (perfluoro- | octane | 74 | plasma polymerization |
| | n-decyl) ethane | | | |
| PTFE | 1H,1H,2H,2H- | decane | 133 | plasma polymerization |
| | heptadecafluorodecyl | | | |
| | acrylate | | | |
| Polyethylene | PFDDE | hexadecane | 73.8 | plasma polymerization |
| Silicon wafer | fluorinated EDOP | hexadecane | 158 | lithography |
| Metal disk | fluorinated EDOP | hexadecane | 145 | electrochemical |
| | | | | polymerization |
| Carbon | PFODS | rapeseed oil | 161 | dip coating |
| nanotubes | | | | |
| Anodized Al | fluorinated silane | rapeseed oil | 150 | dip coating |
| Anodized Al | fluorinated | hexadecane | 136 | dip coating |
| | monoalkylphosphate, | | | |
| | PFODS | | | |
| Anodized Al | PTFE | glycerol | 170 | morphology template |
| template | | | | |
| polymer films | | | | |
| Cellulose | PFODS | caster oil | 166 | vapor deposition |
| aerogel | | hexadecane | 144 | |
| Glass slide | PFODS coated silica | soybean oil | 147 | sol gel |
| Silicon wafer | FDTS | rapeseed oil | 151 | reactive ion-etching |
| Cotton fabric | PFODS | hexadecane | 153 | dipping coating |
| Glass | PMC Zonyl 8740 | dodecanol | 155 | sedimentation, spin coating |
| | coated silica | | | |
| Glass | PDMS, PFOTS | diiodomethane | 141 | spin coating |
| | coated silica | | | |
| Sand paper | Fluoroacrylic | mineral oil | 164 | spray coating |
| | copolymer bound | | | |
| | CNT | | | |
| Silicon wafer, | PFODS coated | silicone oil, | ~160 | liquid phase deposition |
| Steel grid | TiO₂/SWNT | hexadecane | | |
| | composite | | | |
| Glass slide | FDTS | dodecane | 120 | sol gel |
| Glass slide | PMC coated ZnO | DTE 11M, | 154 | spray coating |
| | nanoparticles | Mobil | | |
| Nylon/cotton | FDTS | hexadecane | 156 | sol gel, dip coating |
| fabric | | | | |
| PET, nylon | fluorodecyl | hexadecane | 111 | |
| fabric | POSS/Tecnoflon | rapeseed oil | 125 | |
| Cotton | epichlorohydrin, SA, | APTES-silica | 151-170 | successive coating |
| | PFTDS | NS, GPTMS- | | |
| | | silica NS | | |
| Nylon | PAA, DMTMM, | | Up to | |
| | PFOTA, OTDA | | 158 | |
| Cotton | PFSC | Silica NS (115-198 nm) | 145 | dip coating |
| Cotton | | HDTMS-silica | 141 | dip coating |
| | | NS, GPTMS- | | |
| | | silica NS | | |
| Cotton | PFTDS-PDMS | sunflower oil | 140 | dip coating |
| Cotton | SA, PFTDS | TiO₂ NS | Up to | dip coating |
| | | | 163 | |
| Cotton | epichlorohydrin, | APTES-silica | Up to | successive coating |
| | PFTDS | NS, GPTMS- | 159 | |
| | | silica NS (dual | | |
| | | size, 7-40 nm) | | |

Abbreviations:
Contact Angle (CA),
1H,1H,2H,2H-perfluorooctyltriethoxysilane (PFOTES),
1H,1H,2H,2H-perfluorodecyltrichlorosilane (PFTDS),
1H,1H-perfluorooctylamine (PFOTA),
perfluorooctylated quaternary ammonium silane coupling agent (PFSC),
monoglycidyl ether terminated PDMS (MGE-PDMS),
octadecylamine (OTDA),
poly(allylamine hydrochloride) (PAAH),
poly(diallyldimethylammonium chloride) (PDDA),
PFOTS: 1H,1H,2H,2H-perfluorooctyltrichlorosilane;
PTFE: poly(tetrafluoroethylene).
PFODS: 1H,1H,2H,2H-perfluorodecyltrichlorosilane;
PMMA: poly(methyl methacrylate):
PEMA: polyethyl methacrylate;
EDOP: 3,4-ethylenedioxypyrrole:
PFDDE: 1H,1H,2H-perfluoro-1-dodecene;
FDTS: (heptadecafluoro-1,1,2,2-tetrahydrodecyl)trichlorosilane;
PMC: perfluoroalkyl methacrylic copolymer

While the use of these re-entrant structures have lowered surface tension requirements of the substrates, the fabrication of re-entrant structures (typically via lithography together with chemical etching) tend to be challenging and costly, particularly for flexible substrates. For practical industry applications, essentially all previously developed highly-oleophobic coatings are still based on fluorinated materials with extremely low surface energy.

Very limited efforts have been made towards the development of oleophobic coatings using nonfluorinated materials. Common PDMS has a surface energy of about 22-24 mN/m. Thus, PDMS finishing typically does not provide an efficient oleophobic coating because the surface energy is not low enough. In addition, because of the different nature of the substrates, the PDMS finishing could be problematic in terms of adhesion, uniformity and mechanical properties.

A free-standing omniphobic membrane was prepared via microfluidic silicone oil emulsion templating. This membrane has uniform honeycomb-like micro-cavities with narrow openings, which could be referred to as re-entrant structures. This membrane exhibited oil repellence and flexibility without using any fluorocarbons for surface modification as well as complicated lithograph fabrication. However, the micro-cavity membrane suffers from limited durability against abrasion. The thin top layer of narrow cavity openings is easily worn out making the membrane less oleophobic or even becomes oleophilic (although the membrane can still be superhydrophobic) because of the loss of its re-entrant structure. To generate the well-defined micro-cavity structure, elaborate solvent evaporation on a relatively uniform, flat substrate was used during the emulsion templating. This is more challenging for rough substrates (e.g. upholstery fabrics) due to uneven solvent evaporation as a result of capillary effects. More importantly, the typical size of the micro-cavities is in the range of tens of microns, similar to or even larger than the diameter of many common fibers making microfluidic emulsion templating limited for textile finishing applications, let alone process scalability. A potential solution is to use the membrane as an add-on oil repellent film on a substrate. However, hand feel and appearance of such an oleophobic surface could be compromised.

Based on the foregoing, there is an ongoing and unmet need to find replacements for fluorine-based compounds used in textiles and other industries while maintaining the same level of performance and durability.

### SUMMARY OF THE DISCLOSURE

The present disclosure provides layers having a surface tension of less than or equal to 22 mJ/m² (e.g., less than 22 mJ/m²) disposed on a portion of or all of a surface (e.g., a portion of or all of exterior surfaces) of a substrate (e.g., fabric, fiber, filament, glass, ceramic, carbon, metals, wood, polymer, plastic, paper, membrane, concrete, brick, and the like). The present disclosure also provides methods of making the layers and uses of the layers.

In an aspect, the present disclosure provides layers (e.g., molecularly rough layers) having a surface tension of less than or equal to 22 mJ/m² (e.g., less than 22 mJ/m²) disposed on a portion or all of a surface (e.g., a portion of or all of the exterior surfaces) of a substrate. A layer or layers can be a fluorine-free layer or fluorine-free layers (e.g., substantially fluorine-free layer or substantially fluorine-free layers). A layer can comprise a plurality of individual layers.

A layer can comprise one or more PDMS resin. For example, a resin comprises a plurality of PDMS moieties. For example, a PDMS resin comprises crosslinkable groups, including but not limited to, acrylate, methacrylate, allyl, vinyl, thiol, hydroxyl, silanol, carboxylic acid, aldehyde, amine, isocyanate, azide, alkyne, epoxy, halide, hydrogen, and combinations thereof. The crosslinkable groups can interact with the substrate (e.g., be bonded covalently and/or non-covalently to the substrate) via one or more chemical bonds (e.g., covalent bonds, ionic bonds, hydrogen bonds, van der Waals interactions or a combination thereof). In an example, a PDMS resin comprises a pendent branched PDMS resin and a linear PDMS resin.

A layer can be disposed on a portion or all of a surface (or all of the surfaces or all of the exterior surfaces) of a substrate. A substrate can be of various sizes and shapes. A substrate can have various compositions. A substrate can be a fabric, fiber, filament, glass, ceramic, carbon, metals, wood, polymer, plastic, paper, membrane, concrete, brick, and the like. In an example when the substrate is a fabric, the fabric is a fabric that is naturally or modified to be superhydrophilic, hydrophilic, hydrophobic or superhydrophobic.

In an aspect, the present disclosure provides methods of making layers of the present disclosure. The methods are based on coating a PDMS resin on a substrate.

In various examples, a method of forming a layer (e.g., a molecularly rough layer) having a surface tension of less than or equal to 22 mJ/m² (e.g., a layer comprising a cured PDMS resin having a surface tension less than 22 mJ/m²) disposed on a portion or all of an exterior surface (e.g., all of the exterior surfaces) of a substrate (e.g., substrate described herein such as, for example, a fabric, fiber, filament, glass, ceramic, carbon, metals, wood, polymer, plastic, paper, membrane, concrete, brick, and the like) comprises: providing a substrate (e.g., a fabric); coating (e.g., by dip or spray coating) a portion of or all of a surface of the substrate (e.g., a portion of or all of the exterior surfaces) of the substrate (e.g., fabric) with a PDMS resin (e.g., a pendant branched PDMS resin or linear PDMS resin) (e.g., a PDMS resin of the present disclosure); curing (e.g., thermally curing) the PDMS resin coating, where a layer (e.g., a molecularly rough layer) having a surface tension of less than or equal to 22 mJ/m² (e.g., less than 22 mJ/m²) is formed on a portion of or all of a surface (e.g., a portion of or all of the exterior surfaces) of the substrate (e.g., fabric).

In an aspect, the present disclosure provides articles of manufacture. The articles of manufacture comprise one or more layers of the present disclosure and/or one or more layers made by a method of the present disclosure.

### BRIEF DESCRIPTION OF THE FIGURES

For a fuller understanding of the nature and objects of the disclosure, reference should be made to the following detailed description taken in conjunction with the accompanying figures.

FIG. 1 shows a schematic representation of (a) fibrous structure, (b) T structure and (c) other common reentrant structures.

FIG. 2 shows a schematic of a synthesis of pendant branched PDMS resins, wherein X is chosen from —O—SiOX′ groups, wherein X′ is independently at each occurrence in the —O—SiOX′ group(s) chosen from alkyl groups (e.g., methyl group)

FIG. 3 shows a schematic of a synthesis of linear PDMS resins. The number of the repeating units (R₂OSi) of the PDMS can be 0 or greater. In various examples, the number of repeating units, n, is 10 to 400 (e.g., n is 50) and/or the value of m is at least 1 (e.g., 1 to 50,000, 1 to 25,000, or 1 to 10,000).

FIG. 4 shows deposition of one- and two sided oleophobic coating using a composite nanofluid via dip coating (top) and spray coating (bottom).

FIG. 5 shows SEM images of nanofluid modified oleophobic cotton fabric using a dip-pad-dry-cure process; a) pristine oleophobic fabric, and b) oleophobic fabric after 30 times of laundry washing.

FIG. 6 shows oil stain resistance comparison of the pristine cotton fabric (left) and the nanofluid modified oleophobic cotton fabric (right). A drop of vegetable oil (stained with Oil Red O dye for clarity) has been deposited on both fabrics.

FIG. 7 provides an example of a branched, pendant PDMS resin. The PDMS resin comprises a PDMS polymer with a PDMS backbone. The PDMS polymer can be formed using a multifunctional precursor (e.g., a bifunctional precursor with at least two acrylate groups). The PDMS resin can be colorless.

FIG. 8 provides an example of a PDMS resin. The PDMS resin provides an example of a branched, pendant PDMS resin. The PDMS resin comprises a PDMS polymer with a PDMS backbone and PDMS branches. The PDMS polymer can be formed using a multifunctional precursor (e.g., a precursor with at least three vinyl groups).

FIG. 9 shows synthesis of oleophobic coated substrates via a graft-from approach.

FIG. 10 shows SEM images of the fabric samples: (a) pristine fabric and (b) oleophobic fabric prepared via graft-from atom-transfer radical polymerization.

FIG. 11 shows photos of oleophobic fabrics made of different materials.

### DETAILED DESCRIPTION OF THE DISCLOSURE

Although claimed subject matter will be described in terms of certain examples and/or embodiments, other embodiments, including embodiments that do not provide all of the benefits and features set forth herein, are also within the scope of this disclosure. Various structural, logical, and process step, may be made without departing from the scope of the disclosure.

Ranges of values are disclosed herein. The ranges set out a lower limit value and an upper limit value. Unless otherwise stated, the ranges include all values to the magnitude of the smallest value (either lower limit value or upper limit value) and ranges between the values of the stated range.

The present disclosure provides layers having a surface tension of less than or equal to 22 mJ/m² (e.g., less than 22 mJ/m²) disposed on a portion of or all of a surface (e.g., a portion of or all of exterior surfaces) of a substrate (e.g., fabric, fiber, filament, glass, ceramic, carbon, metals, wood, polymer, plastic, paper, membrane, concrete, brick, and the like).

As used herein, the term “moiety” refers to a part (substructure) or functional group of a molecule. For example, a moiety is a part (substructure) or a functional group of a precursor or PDMS resin. In various examples, a “moiety” refers to a chemical entity that has one terminus that can be covalently bonded to another chemical species (e.g., a group) or multiple (e.g., two) termini that can be covalently bonded to other chemical species. Examples of moieties include, but are not limited to:

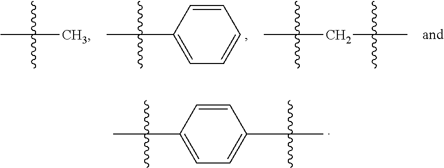

A moiety may be referred to as a group.

As used herein, unless otherwise indicated, the term “aliphatic” refers to branched or unbranched hydrocarbon moieties/groups that are saturated or, optionally, contain one or more degrees of unsaturation. Moieties with degrees of unsaturation include, but are not limited to, alkenyl groups/moieties, alkynyl groups/moieties, and cyclic aliphatic groups/moieties. For example, the aliphatic group can be a C₁ to C₄₀ (e.g., C₁ to C₃₀, C₁ to C₁₂ C₁ to C₁₀, or C₁ to C₅), including all integer numbers of carbons and ranges of numbers of carbons therebetween, aliphatic group/moiety (e.g., alkyl group). Examples of alkyl groups include, but are not limited to, methyl groups, ethyl groups, propyl groups, butyl groups, isopropyl groups, tert-butyl groups, and the like. An aliphatic group/moiety can be unsubstituted or substituted with one or more substituent. Examples of substituents include, but are not limited to, various substituents such as, for example, halogens (—F, —Cl, —Br, and —I), additional aliphatic groups (e.g., alkenes, alkynes), aryl groups, alkoxides, carboxylates, carboxylic acids, ether groups, hydroxyl groups, isocyanate groups, and the like, and combinations thereof.

In various examples, the present disclosure provides layers that combine a low surface energy material with an engineered surface roughness. The surface roughness can be engineered, for example, by exploiting the molecular structure of the base polymer or by stamping. Examples of molecular roughness include, but are not limited to, use of branching or copolymers containing a rigid segment, self-assembly of copolymers, microphase separation of polymer blends, and combinations thereof. Patterning of PDMS can be accomplished by exploiting techniques developed for microcontact printing and soft lithography.

In an aspect, the present disclosure provides layers (e.g., molecularly rough layers) having a surface tension of less than or equal to 22 mJ/m² (e.g., less than 22 mJ/m²) disposed on a portion or all of an exterior surface (e.g., all of the exterior surfaces) of a substrate. A layer or layers can be a fluorine-free layer or fluorine-free layers (e.g., substantially fluorine-free layer or substantially fluorine-free layers). A layer can comprise a plurality of individual layers. In an example, a layer is disposed on a portion of or all of a surface of a substrate.

In an example, a fabric, fiber, filament, glass, ceramic, carbon, metals, wood, polymer, plastic, paper, membrane, concrete, brick, and the like comprises a fluorine-free layer (e.g., a molecularly rough layer) having a surface tension of less than or equal to 22 mJ/m² (e.g., less than 22 mJ/m²) disposed on a portion or all of an exterior surface (e.g., all of the exterior surfaces) of the fabric.

The surface tension of a layer is less than 22, 21, 20, 19, or 18 mJ/m². For example, a layer has a surface tension of 12-22 mJ/m², 12-20 mJ/m², or 12-18 mJ/m².

A layer can have various thicknesses. In various examples, the thickness of a layer is from several nanometers to hundreds of microns. In various other examples, the thickness of a layer is 10 nm-300 microns or 50 nm-100 microns.

A layer can comprise one or more PDMS resin. For example, a resin comprises a plurality of PDMS moieties. For example, a PDMS resin comprises crosslinkable groups, including but not limited to, one or more acrylate, methacrylate, allyl, vinyl, thiol, hydroxyl, silanol, carboxylic acid, aldehyde, amine, isocyanate, azide, alkyne, epoxy, halide, hydrogen, and combinations thereof. The crosslinkable groups can interact with the substrate (e.g., be bonded covalently and/or non-covalently to the substrate) via one or more chemical bonds (e.g., covalent bonds, ionic bonds, hydrogen bonds, van der Waals interactions or a combination thereof). In an example, a PDMS resin comprises a pendent branched PDMS resin and a linear PDMS resin.

A PDMS resin can comprise various PDMS polymers and/or PDMS copolymers (e.g., random copolymers). A PDMS resin can comprise one or more polymer chains. The polymer chains may have various structures. A resin may comprise a combination of PDMS polymers and/or PDMS copolymers. In various examples, a PDMS resin comprises one or more poly(dimethylsiloxane), each poly(dimethylsiloxane) comprising one or more poly(dimethylsiloxane) moieties (e.g., linear or branched poly(dimethylsiloxane) moiet(ies)). The moiet(ies) may be terminal moiet(ies), such as for example, group(s). Optionally, the poly(dimethylsiloxane)(s) independently comprise one or more pendant groups having the following structure:

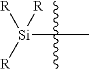

(e.g.,

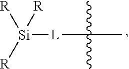

wherein L is a linking group), where R is independently at each occurrence in the poly(dimethylsiloxane)(s) chosen from alkyl groups and —O—SiOR′ groups, where R′ is independently at each occurrence in the —O—SiOR′ group(s) chosen from alkyl groups (e.g., methyl group). In various examples, a PDMS resin comprises one or more polymers, each polymer comprising one or more backbone chosen from a backbone chosen from linear or branched poly(dimethylsiloxane), hydrocarbon polymer (e.g., polyethylene, polypropylene, polybutylene, and the like), polyacrylate polymer, a poly(methacrylate), poly(styrene), poly(vinylester), poly(allylether), polyester, polyurethane, polyurea, polyamide, polyimide, polysulfone, and combinations thereof. Optionally, at least one pendant group having the following structure:

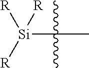

(e.g.,

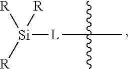

where L is a linking group), where R is independently at each occurrence chosen from alkyl groups and —O—SiOR′ groups, wherein R′ groups are alkyl groups, where the layer is disposed on a portion of or all of an exterior surface of a substrate. The linking group can be a group comprising alkyl, aryl group, silyl moieties, and the like, and combinations thereof (e.g. a —CH₂— group, a —CH₂CH₂— group, a —CH₂CH₂CH₂— group, a

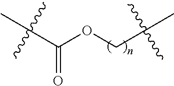

group, a

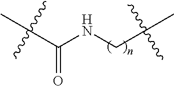

group, a

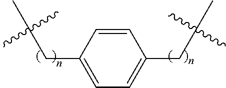

group, a —Si(CH₃)₂O—, a —CH₂O-group, a —CH₂CH₃O— group, a —CH₂N— group, a —CH₂SO₂— group, where n is 0-40, including all integer values and ranges therebetween). Examples of linking groups are described herein.

The PDMS resin can comprise a polymer having a molecular weight of 140 g/mol or more (e.g., 400 g/mol or more, or 600 g/mol or more). It may be desirable that the molecular weight of the polymer be above 140 g/mol, (e.g., over 400 g/mol, 600 g/mol, 1000 g/mol, 3000 g/mol, or 4000 g/mol), to achieve a desirable thickness of a layer. In an example, the molecular weight is less than or equal to 10,000 g/mol.

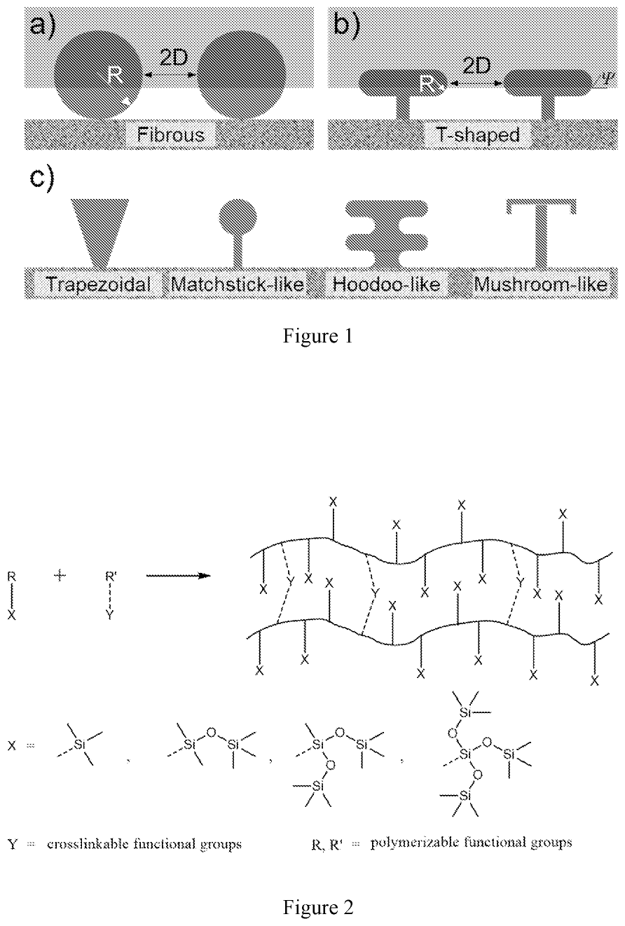

A PDMS resin can be a pendant branched PDMS resin. A pendant branched PDMS resin can comprise a backbone comprising a plurality of aliphatic moieties and/or aliphatic groups (e.g., alkanediyl/alkenediyl moieties and/or alkanediyl/alkenediyl groups) and a plurality of pendant groups (e.g., PDMS pendant groups). In an example, a pendant branched PDMS resin is a resin formed by polymerization of one or more alkylsilyl compounds comprising one or more aliphatic moieties and/or aliphatic groups (e.g., alkanediyl/alkenediyl moieties and/or alkanediyl/alkenediyl groups), which can be referred to as precursors (e.g., monomers). For example, a pendant branched PDMS resin is a resin formed by polymerization of pendant forming precursors such as, for example, tris(trialkylsiloxy)silyl alkyl acrylate, and one or more crosslinking precursors, which can crosslink with the substrate, such as, for example, alkylacryloxyalkyltrialkoxysilane. Crosslinking precursors can be co-monomers with, for example, one or more hydroxyl, silanol, epoxy, carboxylic, aldehyde, amino, or isocyanate crosslinkable groups, or a combination thereof. The individual aliphatic moieties and/or aliphatic groups (e.g., alkanediyl/alkenediyl moieties and/or alkanediyl/alkenediyl groups) independently at each occurrence can be any molecular linkage (e.g., moiety/group) comprising a number of carbons from C₁ to C₄₀ (e.g., C₁-C₃₀, C₁-C₁₀, or C₁-C₅), including all integer number of carbons and ranges therebetween. In an example, a pendant branched PDMS resin is a resin formed by polymerization of tris(trimethylsiloxy)silyl propyl methacrylate and vinyltrimethoxysilane. See, e.g., FIG. 2. The molar ratio of tris(trialkylsiloxy)silyl alkyl acrylate(s) to alkylacryloxyalkyltrialkoxysilane(s) (e.g., tris(trimethylsiloxy)silyl propyl methacrylate to vinyltrimethoxysilane) is generally higher than 1. In an example, the ratio is from 3 to 20.

Examples of crosslinkable moieties include, but are not limited to:

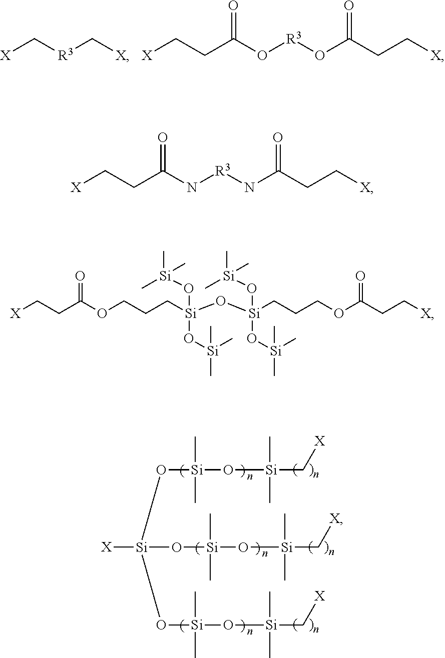

and combinations thereof, where R³ is a 1 to 40 carbon hydrocarbon, including all integer carbon values and ranges therebetween (e.g., methylene, ethylene, propylene, phenyl, diphenyl, naphthyl, and the like), n is 0-600, including all values and ranges therebetween, and X is a crosslinkable group including but not limited to the following: acrylate, methacrylate, allyl, vinyl, thiol, hydroxyl, silanol, carboxylic acid, aldehyde, amine, isocyanate, azide, alkyne, epoxy, halide, hydrogen, and combinations thereof. In various examples, the crosslinkable moieties are crosslinking moieties when the one or more of the crosslinkable group(s) are reacted (e.g., reacted with crosslinkable groups of a different polymer chain, the same polymer chain, a substrate, or a combination thereof).

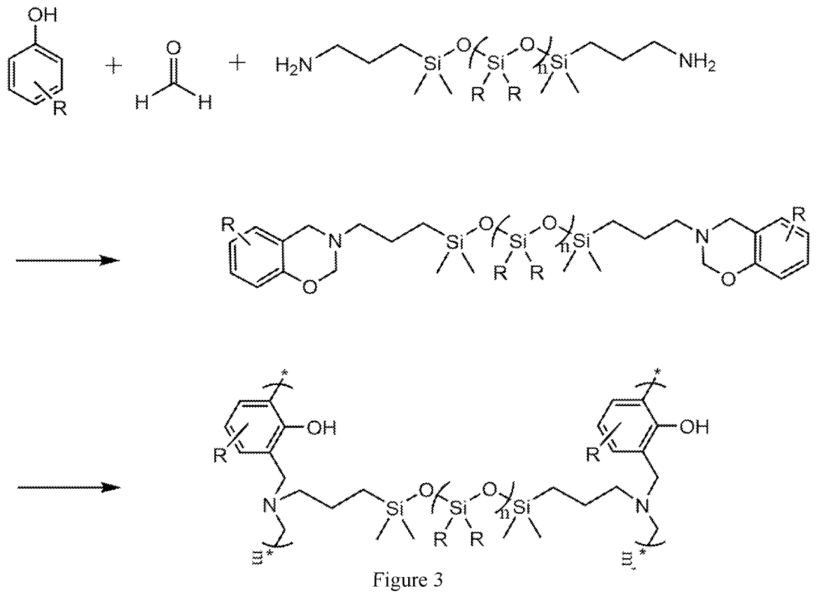

A PDMS resin can be a linear PDMS resin. A linear PDMS resin can comprise a backbone comprising a plurality of PDMS aliphatic moieties and/or aliphatic groups (e.g., alkanediyl/alkenediyl moieties and/or alkanediyl/alkenediyl groups) and, optionally, a plurality of pendant groups (e.g., PDMS pendant groups). For example, the PDMS resin is a linear PDMS resin with binding groups to the substrates (e.g., a resin formed by polymerization of reactive functional group terminated (e.g., amine terminated) PDMS, a phenol (e.g., bisphenol A), and paraformaldehyde; PDMS terminated with silanol, epoxy, carboxylic, aldehyde, isocyanate, thiol, vinyl, hydrogen and hydroxyl group). See, e.g., FIG. 3. The aliphatic moieties and/or aliphatic groups (e.g., alkanediyl/alkenediyl moieties and/or alkanediyl/alkenediyl groups) of the reactive functional group terminated PDMS and/or PDMS terminated with silanol, epoxy, carboxylic, aldehyde, isocyanate, thiol, vinyl, hydrogen and hydroxyl groups, or combinations thereof, can independently at each occurrence be any molecular linkage comprising a number of carbons from C₁ to C₄₀ (e.g., C₁-C₃₀, C₁-C₁₀, or C₁-C₅). In various examples, the number of the repeating units (e.g., R₂OSi—) (e.g., C₂H₆OSi or n in FIG. 3) of the PDMS polymer is 0 or greater. In various examples, the number of repeating units is 0 to 400, including all integer number of repeating units and ranges therebetween. In various examples, the number of repeating units in the PDMS polymer (e.g., m in FIG. 3) is at least 1. In various examples, the number of repeating units in the PDMS polymer (e.g., m in FIG. 3) is 1-50,000, 1-25,000, or 1-10,000. In various examples, the number of repeating units in the PDMS polymer (e.g., m in FIG. 3) is 5-50,000, 5-25,000, or 5-10,000. In various examples, m is 2,000. In various examples, n can be 0-400. In various examples, n is 50.

Any phenol can be used. Examples of suitable phenols include, but are not limited to, phenols comprising at least two hydroxyl groups and one or more short (e.g., C₁ to C₅ or C₁ to C₄) alkyl groups attached to one or more benzene ring or with hydroxyls directly attached to one or more aromatic ring (e.g., a hydroxylated C₅ to C₁₆ aromatic group/moiety, such as, for example, hydroxylated naphthalene, hydroxylated pyrene, hydroxylated anthracene, and the like). In an example, the phenol is bis-phenol A.

A film can comprise nanoparticles (e.g., silica nanoparticles). The nanoparticles can be multifunctional nanoparticles. “Multifunctional nanoparticles” means that more than one type of functional groups were immobilized on the nanoparticles, e.g., the silanol groups on nanoparticles to improve the compatibility with the PDMS resin and the trimethylsiloxyl groups to reduce the surface energy. The silica nanoparticles and resin and/or substrate can have covalent and/or hydrogen bonds from the surface functional groups of these nanoparticles.

The nanoparticles can be metal, carbon, metal oxide, or semi-metal oxide (e.g., silica) nanoparticles. The nanoparticles can be surface functionalized with low surface energy groups (e.g., trimethylsiloxyl, methyl, t-butyl, benzoxazine, PDMS groups, and the like). The nanoparticles can have various morphologies. In various examples, the nanoparticles are spherical, nanoplates, nanotubes, nanorods, nanowires, hierarchical structures generated by such nanoparticles, or a combination thereof. In an example, a layer comprises a plurality of silica nanoparticles (e.g., Ludox HS silica, or other commercially available colloidal silica particles). The nanoparticles can be present in various amounts. In various examples, the nanoparticles are present in a layer at 0-95 wt %, including all integer number wt % values and ranges there between, based on the total weight of the layer. In an example, the nanoparticles are present in a layer at 20-40 wt %. The interaction between the silica nanoparticles and resin or fabric/fiber can be in the form of covalent and/or hydrogen bonds involving surface functional groups of the nanoparticles.

A layer can be disposed on a portion or all of an exterior surface (or all of the exterior surfaces) of a substrate. A substrate can be of various sizes and shapes. A substrate can have various compositions. Examples of substrate materials include, but are not limited to, fabrics, fibers, filaments, glasses, ceramics, carbons, metals, woods, polymers, plastics, papers, membranes, concrete, bricks, and the like.

A substrate can be a fabric that is naturally or modified to be superhydrophilic, hydrophilic, hydrophobic or superhydrophobic. A fabric can be a cotton, PET (polyethylene terephthalate), blend (e.g., cotton/PET blends and the like), nylon, polyester, spandex, silk, wool, viscose, cellulose fiber (e.g., TENCEL®), acrylic, polypropylene, or blends thereof. The fabric can be leather. A fabric can have a woven (e.g., plain, twill, satin weave, and the like), knitted (e.g. single jersey, double jersey, pique, mesh, and the like), or non-woven (e.g., felts, fibrous matts, membrane, film, leather, paper, and the like) structure.

A substrate may comprise one or more re-entrant structures. Non-limiting examples of re-entrant structures include fibrous structures (e.g., non-limiting examples of fibrous structures as shown in FIG. 1a), T-shaped structures (e.g., non-limiting examples of fibrous structures as shown in FIG. 1b) and derivative structures, such as, for example, trapezoidal, matchstick-like, hoodoo-like/inverse opal and mushroom-like structures (e.g., non-limiting examples of derivative structures are shown in FIG. 1c). A substrate may comprise two or more different (e.g., different in terms of one or more properties such as, for example, one or more dimension, one or more type of re-entrant structures, and the like) re-entrant structures. The oleophobic behavior of a layer disposed on a substrate with these structures may be determined by the capillary length, the radius of the overhang R, the microstructure spacing D, and the local texture angle ψ, for example, as represented in FIG. 1. Compared with the fibrous structure, the T-shaped structure may have increased oil repellency as it allows to maximize these parameters simultaneously. In an example, a substrate does not include any re-entrant structures.

A layer can be disposed on a fabric that has a superhydrophilic layer disposed on a portion of an exterior surface of the fabric. Non-limiting examples of superhydrophilic layers can be found in U.S. patent application Ser. No. 14/122,535 (Wang et al. “Antifouling Ultrafiltration and RO/FO Membranes”), the disclosure with respect to superhydrophilic layers and methods of making superhydrophilic layers therein is incorporated herein by reference. In an example, a layer of the present disclosure and a superhydrophilic layer are disposed on opposite sides of a fabric.

A superhydrophilic layer can comprise a plurality of superhydrophilic nanoparticles. The hydrophilic nanoparticles are silica nanoparticles that are surface functionalized with alkyl siloxane linker groups. In various examples, a superhydrophilic layer has a surface that has a contact angle less than 30 degrees, 25 degrees, 20 degrees, 15 degrees, 10 degrees, or 5 degrees. Superhydrophilic layers can be formed from nanoparticles made by methods known in the art.

A layer is oleophobic. A layer can be lipophobic and oleophobic. A layer can be lipophobic, oleophobic, and hydrophobic. “Oleophobic” refers to the physical property of a molecule that is seemingly repelled from oil. Oleophobicity, or oil repellency of the layer, can be evaluated by AATCC® Test Method 118-2013. In various examples, a layer passes AATCC® Test Method 118-2013 for one or more oil (e.g., one or more oil set out in AATCC® Test Method 118-2013). Lipophobicity, also sometimes called lipophobia, is a chemical property of chemical compounds which means “fat rejection,” literally “fear of fat.” Lipophobic compounds are those not soluble in lipids or other non-polar solvents, e.g., water is lipophobic.

In an aspect, the present disclosure provides methods of making layers of the present disclosure. In various examples, the methods are based on coating a PDMS resin on a substrate, which may be referred to as graft-to methods. In various other examples, a PDMS resin of formed by in situ polymerization, which may be referred to as graft-from methods.

In various examples, a method of forming a layer (e.g., a molecularly rough layer) having a surface tension of less than or equal to 22 mJ/m² (e.g., a layer comprising a cured PDMS resin less than 22 mJ/m²) disposed on a portion or all of an exterior surface (e.g., all of the exterior surfaces) of a substrate (e.g., substrate described herein such as, for example, a fabric fiber, filament, glass, ceramic, carbon, metals, wood, polymer, plastic, paper, membrane, concrete, brick, and the like) comprises: providing a substrate (e.g., a fabric); coating (e.g., by dip or spray coating) a portion of or all of a surface of the substrate (e.g., a portion of or all of the exterior surfaces) of the substrate (e.g., fabric) with a PDMS resin (e.g., a pendant branched PDMS resin or linear PDMS resin) (e.g., a PDMS resin of the present disclosure); curing (e.g., thermally curing) the PDMS resin coating, where a layer (e.g., a molecularly rough layer) having a surface tension of less than or equal to 22 mJ/m² (e.g., less than 22 mJ/m²) is formed on a portion of or all of a surface (e.g., a portion of or all of the exterior surfaces) of the substrate (e.g., fabric).

Curing may result in crosslinking (e.g., formation of one or more covalent bonds) between one or more polymer chains of the layer and/or one or more polymer chains and the substrate. Crosslinking may form a crosslinking moiety (e.g., from reaction of one or more crosslinkable moieties).

Various coating methods can be used. Examples of coating methods include, but are not limited to, spray coating, dip coating, floating knife coating, direct roll coating, padding, calender coating, foam coating, and painting.

A PDMS resin can be (e.g., comprise) a mixture of nanoparticles, a PDMS resin, and optionally, a solvent. Such a resin can be referred to as a “composite nanofluid.” In various examples, a substrate is coated with a composite nanofluid. It is considered that the nanoparticles increase the surface roughness of the layer. Additionally, the nanoparticles can increase mechanical durability and strength of a layer (e.g., a fabric with a layer disposed on a least a portion or all of an exterior surface (e.g., all of the exterior surfaces) of the fabric).

A layer or layers can be formed by in situ polymerization. For example, a layer is grown via polymerization initiated from the substrate (e.g., one or more group disposed on a substrate. For example, the polymerization is a radical polymerization. In various examples, a radical polymerizations is a living polymerization, such as, for example, an atom-transfer radical polymerization (ATRP).

An example of in situ polymerization comprises contacting a substrate comprising a plurality of functional groups capable of initiating polymerization of methylsiloxane precursors (e.g., comprising one or more

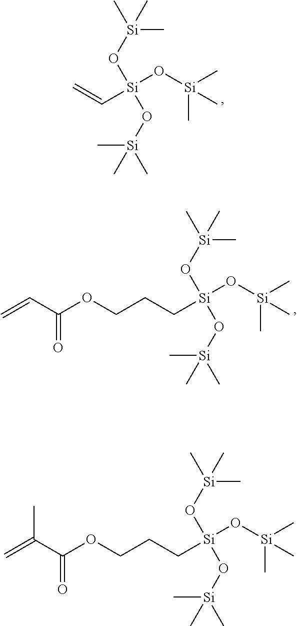

groups, and the like, or a combination thereof, disposed on a surface thereof) with a reaction mixture comprising one or more methylsiloxane precursors and
(i) one or more radical initiator (e.g., halide initiators, such as, for example,

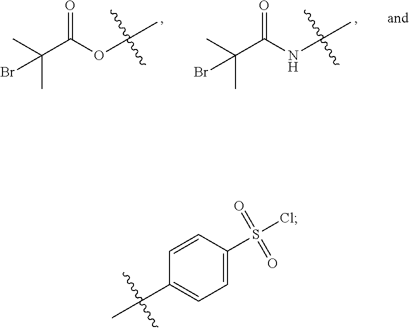

azo radical initiators, such as, for example, azobisisobutyronitrile (AIBN); peroxides, such as, for example, benzoyl peroxide; alkoxyamines, such as, for example, 2,2,6,6-tetramethylpiperidin-1-yl) oxyl; chain transfer agents, such as, for example cyanomethyl [3-(trimethoxysilyl)propyl] trithiocarbonate, and the like, or a combination thereof); or
(ii) one or more activator comprising one or more metal catalyst (e.g., Cu(I), Cu(II), Fe(II), Fe(III), Co(II), and the like, and combinations thereof) and one or more amine (e.g., diethylenetriamine, triethylenetetramine, N,N-bis(2-pyridylmethyl)amine, tris[2-aminoethyl]amine, 1,4,8,11-tetraazacyclotetradecane, 2,2′-bipyridine, 4,4′-di(5-nonyl)-2,2′-bipyridine, N,N,N′,N′-tetramethylethylenediamine, N-propyl(2-pyridyl)methanimine, 2,2′:6′,2″-terpyridine, 4,4′,4″-tris(5-nonyl)-2,2′:6′,2″-terpyridine, N,N,N′,N″,N″-pentamethyldiethylenetriamine, N,N-bis(2-pyridylmethyl)octylamine, 1,1,4,7,10,10-hexamethyltriethylenetetramine, tris[2-(dimethylamino)ethyl]amine, tris[(2-pyridyl)methyl]amine, 1,4,8,11-tetraaza-1,4,8,11-tetramethylcyclotetradecane, N,N,N′,N′-tetrakis(2-pyridylmethyl)ethylenediamine, and the like, combinations thereof), where a layer comprising an initiator layer and/or a poly(dimethylsiloxane) layer disposed on a surface of the substrate is formed.

A substrate can be pretreated prior to coating. In an example, nanoparticles are deposited and/or grown on a portion or all of an exterior surface (e.g., all of the exterior surfaces) of a substrate. In various examples, a method comprises forming a layer comprising a plurality of nanoparticles on all or a portion or all of an exterior surface (e.g., all of the exterior surfaces) of the fabric prior to formation of a layer of the present disclosure. In various examples, the forming comprises coating (e.g., by dip coating or spray coating) a portion or all of an exterior surface of the fabric with a silica sol (e.g., a silica sol formed by hydrolyzing one or more tetraalkoxysilanes (e.g., in an alcohol/water solution) (e.g., under alkaline conditions) and drying the coated fabric. Combinations of tetraalkoxysilanes can be used. Examples of tetraalkoxysilanes include, but are not limited to, tetramethoxysilane, tetraethoxysilane, tetrapropyl orthosilicate, tetrabutyl orthosilicate, and combinations thereof. The silica sol can also be formed by acidifying sodium silicate.

In an example, a method comprising pretreatment of the substrate further comprises contacting the dried fabric with silica nanoparticles (e.g., a suspension of silica nanoparticles).

A substrate can be cleaned prior to use. In an example, a substrate (e.g., a fabric or fabric having a plurality of nanoparticles disposed thereon) is cleaned (e.g., plasma cleaned, oxidized, rinsed with solvents, such as, for example, water and/or other solvents, such as, for example, organic solvents) prior to coating with a silica sol.

The coating and curing can be repeated a desired number of times. It may be desirable to repeat the coating and curing to provide a layer having a desired thickness. In various examples, the coating and curing are repeated 1 to 20 times, including all integer number of repetitions therebetween.

In various examples, a method further comprises forming additional surface roughness on the film. Surface roughness can be formed by, for example, nanofabrication, electrospinning, forced spinning, extrusion, mechanical stamping, abrasion, etching, or a combination thereof.

In an aspect, the present disclosure provides articles of manufacture. The articles of manufacture comprise one or more layers of the present disclosure and/or one or more layers made by a method of the present disclosure.

Examples of articles of manufacture include, but are not limited to, textiles, clothing (e.g., clothing, such as, for example, children's clothing, adult clothing, industrial work clothing, and the like) such as, for example, shirts, jackets, pants, hats, ties, coats, shoes, and the like, food packaging, eye glasses, displays (e.g., touch screens), scanners (e.g., finger print scanners), airplane coatings, sporting goods (e.g., tents, uniforms, and the like), building materials (e.g., windows), windshields.

Articles of manufacture can be used in various industries. Examples of industries include, but are not limited to, aerospace, automotive, building and construction, food processing, and electronics.

The steps of the methods described in the various embodiments and examples disclosed herein are sufficient to carry out the methods of the present disclosure. Thus, in various examples, a method consists essentially of a combination of the steps of the methods disclosed herein. In various other examples, a method consists of such steps.

The following Statements provide embodiments and/or examples of layers of the present disclosure (e.g., molecularly rough layers having a surface tension of less than or equal to 22 mJ/m² (e.g., 12-22 mJ/m²)), methods of the present disclosure (e.g., methods of manufacture of layers of the present disclosure), and articles of manufacture of the present disclosure (e.g., articles of manufacture comprising one or more layers of the present disclosure):

Statement 1. A layer (e.g., a molecularly rough layer) of the present disclosure having a surface tension of less than or equal to 22 mJ/m² (e.g., 12-22 mJ/m²) disposed on a portion or all of an exterior surface (e.g., all of the exterior surfaces) of a substrate.

Statement 2. A layer (e.g., a layer disposed on a substrate) comprising one or more PDMS resin, each PDMS resin comprising:
i) one or more poly(dimethylsiloxane), each poly(dimethylsiloxane) comprising one or more poly(dimethylsiloxane) moieties (e.g., linear or branched poly(dimethylsiloxane) moiet(ies)), and
optionally, the poly(dimethylsiloxane)(s) independently comprise one or more pendant groups having the following structure:

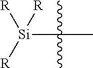

(e.g.,

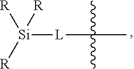

where L is a linking group, where linking group can be a group comprising alkyl, aryl group, silyl moieties, and the like, and combinations thereof (e.g. a —CH₂— group, a —CH₂CH₂— group, a —CH₂CH₂CH₂— group, a

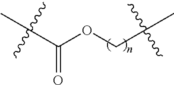

group, a

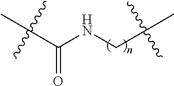

group, a

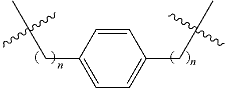

group, a —Si(CH₃)₂O—, a —CH₂O— group, a —CH₂CH₃O— group, a —CH₂N— group, a —CH₂SO₂— group, where n is 0-40, including all integer values and ranges therebetween)), where R is independently at each occurrence in the poly(dimethylsiloxane)(s) chosen from alkyl groups and —O—SiOR′ groups, where R′ is independently at each occurrence in the —O—SiOR′ group(s) chosen from alkyl groups (e.g., methyl group); and/or
ii) comprises one or more polymers, each polymer comprising:
one or more backbone chosen from a backbone chosen from linear or branched poly(dimethylsiloxane), hydrocarbon polymer (e.g., polyethylene, polypropylene, polybutylene, and the like), polyacrylate polymer, a poly(methacrylate), poly(styrene), poly(vinylester), poly(allylether), polyester, polyurethane, polyurea, polyamide, polyimide, polysulfone, and combinations thereof, and
optionally, at least one pendant group having the following structure:

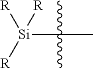

(e.g.,

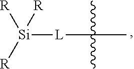

where L is a linking group, where linking group can be a group comprising alkyl, aryl group, silyl moieties, and the like, and combinations thereof (e.g. a —CH₂— group, a —CH₂CH₂— group, a —CH₂CH₂CH₂— group, a

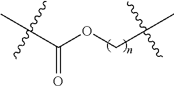

group, a

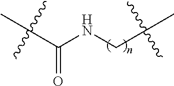

group, a

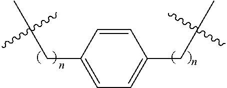

group, a —Si(CH₃)₂O—, a —CH₂O— group, a —CH₂CH₃O— group, a —CH₂N— group, a —CH₂SO₂— group, where n is 0-40, including all integer values and ranges therebetween)), where R is independently at each occurrence chosen from alkyl groups and —O—SiOR′ groups, where R′ groups are alkyl groups, where the layer is disposed on a portion of or all of a surface of a substrate.

Statement 3. The layer of Statement 2, where the one or more poly(dimethylsiloxane) comprises linear poly(dimethylsiloxane) moiet(ies), branched poly(dimethylsilioxane)s moiet(ies), or a combination thereof.

Statement 4. The layer of any one of the preceding Statements, where the PDMS resin is a linear PDMS resin (e.g., a PDMS resin with binding groups to the substrates) (e.g., a resin formed by polymerization of amine terminated PDMS, a phenol with a hydroxyl group and short alkyl groups attached to the benzene ring (<C₅) or with hydroxyls directly attached to the aromatic ring (e.g., bisphenol A), and paraformaldehyde; PDMS terminated with silanol, epoxy, carboxylic, aldehyde, isocyanate, thiol, vinyl, hydrogen, hydroxyl groups, or a combination thereof). See, e.g., FIG. 3. For example, the alkyl moieties of the amine terminated PDMS precursor or PDMS terminated with silanol, epoxy, carboxylic, aldehyde, isocyanate, thiol, vinyl, hydrogen, hydroxyl groups, or a combination thereof are independently at each occurrence C₁ to C₄₀, including all integer number of carbons and ranges therebetween (e.g., C₁ to C₃₀, C₁ to C₁₀, or C₁ to C₅).

Statement 5. The layer of any one Statements 2-4, where the one or more poly(dimethylsiloxane) is:

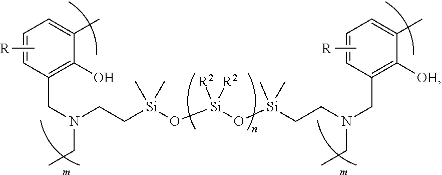

where R² is independently at each occurrence chosen from H, hydrocarbon groups having 1 to 40 carbons, or —O—SiOR′ groups, where R′ groups are alkyl groups (e.g., C₁ to C₄₀, C₁ to C₃₀, C₁ to C₁₀, or C₁ to C₅); and n is 0-400 and m is 1-50,000.

Statement 6. The layer of any one of Statements 2-6, where at least one of the one or more poly(dimethylsiloxane) or linear or branched poly(dimethylsiloxane) has one or more crosslinkable groups.

Statement 7. The layer of any one of Statements 2-6, where the crosslinkable groups are selected from acrylate, methacrylate, allyl, vinyl, thiol, hydroxyl, silanol, carboxylic acid, aldehyde, amine, isocyanate, azide, alkyne, epoxy, halide, hydrogen, and combinations thereof.

Statement 8. The layer of any one of Statements 2-7, the pendant branched PDMS is formed by polymerization of one or more tris(trialkylsiloxy)silyl vinyl compound (e.g., tris(trialkylsiloxy)silyl alkylacrylates such as, for example, tris(trialkylsiloxy)silyl methacrylate, and the like) and trimethoxysilane vinyl compound (e.g., alkylacryloxyalkoxytrimethoxysilanes and the like), where the alkyl moieties (e.g., alkyl moiet(ies) and/or alkyl group(s)) are independently at each occurrence C₁ to C₄₀ alkyl moieties. See, e.g., FIG. 2.

Statement 9. The layer of any one of Statements 2-8, where the molar ratio of tris(trialkylsiloxy)silyl alkyl acrylate and vinylsilane (e.g., tris(trimethylsiloxyl)silyl propyl methacrylate to vinyltrimethoxysilane) used to produce the PDMS resin or moieties in the PDMS resin derived from these precursors is greater than 1 (e.g., 3-20).

Statement 10. The layer of any one of Statements 2-9, where the alkyl moieties are independently at each occurrence C₁ to C₃₀, C₁ to C₁₀ alkyl moieties or C₁ to C₅ alkyl moieties.

Statement 11. The layer of any one of Statements 2-10, where the pendant group is chosen from:

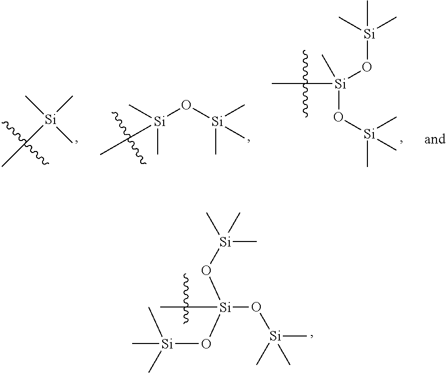

and optionally, the pendant group is covalently bonded to the poly(dimethylsilioxane) resin or backbone by a linking group.

Statement 12. The layer of any one of Statements 2-11, where the poly(dimethylsiloxane) has the following structure:

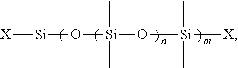

where n is 0-600, and m is 0-3, and X is a crosslinkable group including but not limited to the following: acrylate, methacrylate, allyl, vinyl, thiol, hydroxyl, silanol, carboxylic acid, aldehyde, amine, isocyanate, azide, alkyne, epoxy, halide, hydrogen, and combinations thereof.

Statement 13. The layer of any one of Statements 2-12, where the number of R₂OSi (e.g., C₂H₆OSi) repeat units of the one or more poly(dimethylsiloxane) moiet(ies) or the linear or branched poly(dimethylsiloxane)(s) backbone is 0 to 400.

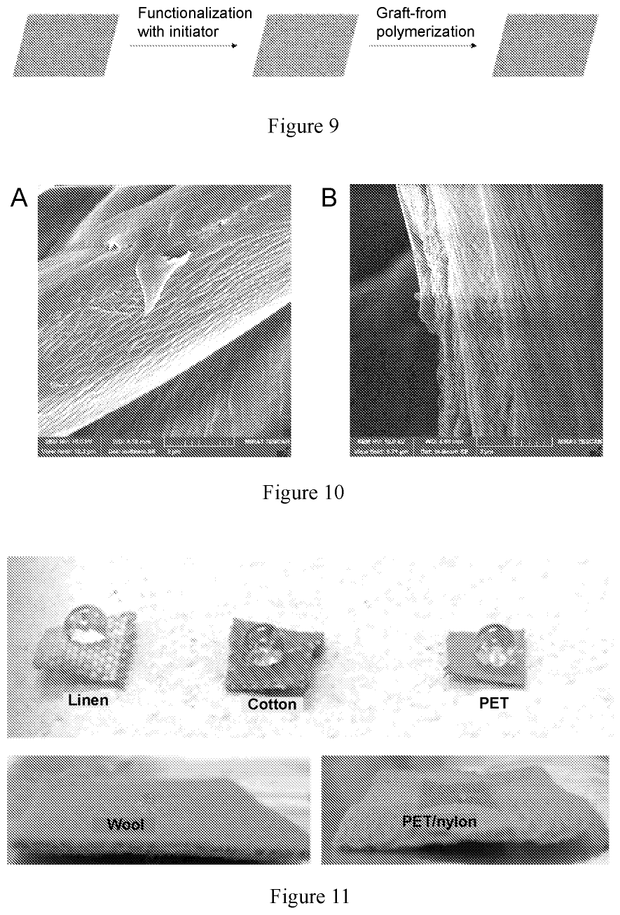

Statement 14. The layer of any one of Statements 2-13, where the number of the repeating units (e.g., C₂H₆OSi) of the PDMS is more than 2, preferably from 10-400. Other than the graft-to methods (e.g., dip coating, spray coating, emulsion/foam coating, etc.), the coating can be applied to the substrates via a graft-from approach (e.g., as shown in FIG. 9). The initiators can be a reversible-deactivation radical generator, such as, for example, a compound comprising one or more organic halide moieties (e.g., alkyl halides), or one or more alkoxyamine moieties, or a suitable chain transfer agent such as, for example, one or more thiocarbonylthio moieties. The monomers can be one or more alkylsilyl compounds comprising one or more aliphatic moieties and/or aliphatic groups.

Statement 15. The layer of any one of Statements 2-14, where the layer is cured.

Statement 16. The layer of any one of Statements 2-15, where the layer further comprises at least one crosslink (e.g., more than two, more than 5, more than 10 crosslinks, or more than 25 crosslinks) between two polymer chains of a PDMS resin (which may be the same or different polymer chains of the PDMS resin) and/or at least one crosslink (e.g., more than two, more than 5, more than 10 crosslinks, or more than 25 crosslinks) between a polymer chain of a PDMS resin (which may be the same or different polymer chains of the PDMS resin) and the substrate.

Statement 17. The layer of any one of Statements 2-16, where the layer further comprises one or more crosslinking moieties chosen from:

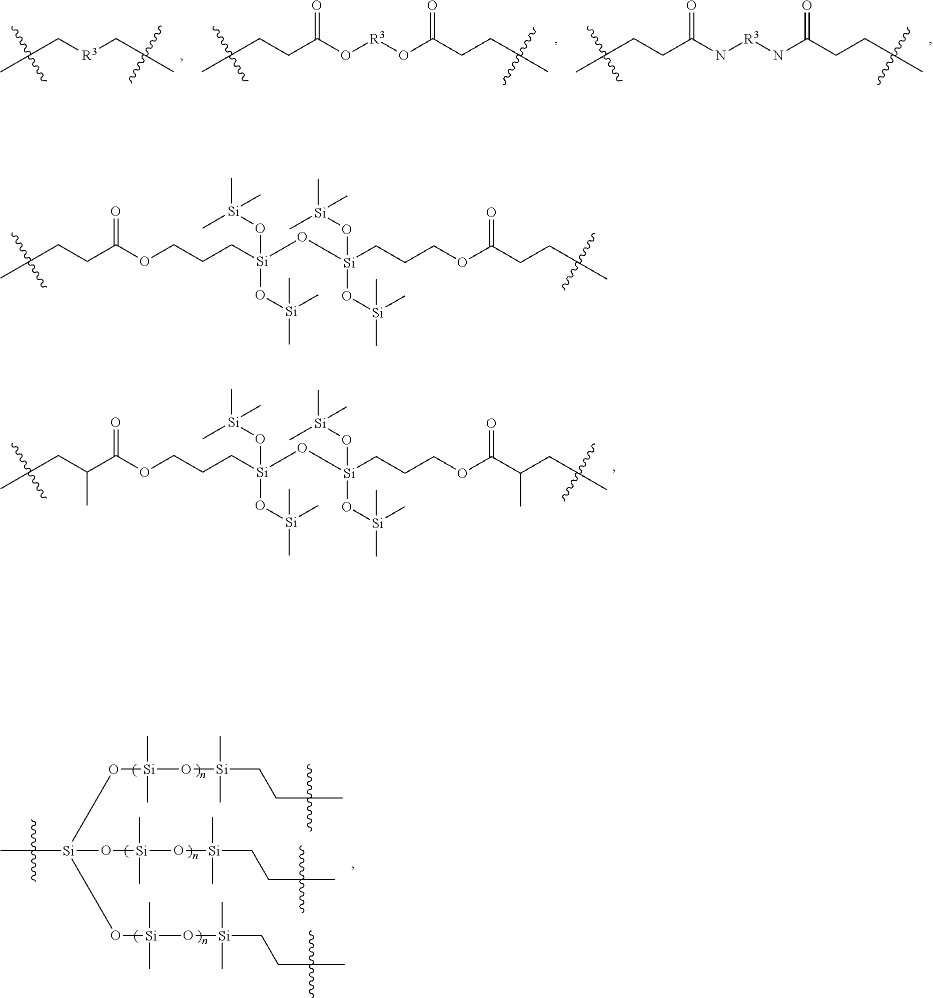

and combinations thereof, where R³ is a hydrocarbon group having 1 to 40 carbons, including all integer carbon values and ranges therebetween (e.g., methylene, ethylene, propylene, phenyl, biphenyl, naphthyl, and the like), and where n is 0-600, including all values and ranges therebetween.

Statement 18. The layer of any one of the Statements 2-17, where the layer comprises a plurality of nanoparticles disclosed herein (e.g., silica nanoparticles such as Ludox HS silica and other commercially available colloidal silica particles).

Statement 19. The layer of Statement 18, where the plurality of nanoparticles are selected from the group consisting of silica nanoparticles.

Statement 20. The layer of any one of Statements 18 or 19, where the weight percentage of the nanoparticles is 1-98 wt % (e.g., 1-95 wt % or 1-50 wt %) based on the total weight of the layer.

Statement 21. The layer of any one of Statements 18-20, where the weight percentage of the nanoparticles can be 0-95 wt %, preferably from 20-40 wt %.

Statement 22. The layer of any one of the preceding Statements, where the substrate is a substrate disclosed herein.

Statement 23. The layer of any one of the preceding Statements, where the thickness of the layer is 10 nm-300 microns (e.g., 50 nm-100 microns).

Statement 24. The layer of any one of the preceding Statements, where the substrate is a fabric, fiber, filament, glass, ceramic, carbon, metals, wood, polymer, plastic, paper, membrane, concrete, brick, and the like.

Statement 25. The layer of Statement 24, where the fabric is chosen from cotton, PET, cotton/PET blends, nylon, polyester, spandex, silk, wool, viscose, cellulose fiber, acrylic, polypropylene, blends thereof (e.g., a blend of two or more yarns, which may form a fabric, comprising cotton, PET, cotton/PET blends, nylon, polyester, spandex, silk, wool, viscose, cellulose fiber, acrylic, polypropylene yarns as a fabric material), leather, and combinations thereof.

Statement 26. The layer of Statement 25, where the substrate is a fabric that has a superhydrophilic layer disposed on a portion of an exterior surface of the fabric.

Statement 27. The layer of any one of Statements 2-26, where the layer exhibits a surface tension of less than or equal to 22 mJ/m².

Statement 28. The layer of any one of Statements 2-27, where the layer having a surface tension of less than or equal to 22 mJ/m² and superhydrophilic layer are disposed on opposite sides of a fabric.

Statement 29. The layer of any one of the preceding Statements, where the substrate and/or layer is fluorine-free.

Statement 30. The layer of any one of the preceding Statements, where the layer passes AATCC® Test Method 118-2013 for one or more oil (e.g., one or more oil set out in AATCC® Test Method 118-2013).

Statement 31. A method of forming a layer (e.g., a molecularly rough layer) of the present disclosure (e.g., a layer having a surface tension of less than 22 mJ/m²) (e.g., a layer comprising a cured PDMS resin) disposed on a portion or all of an exterior surface (e.g., all of the exterior surfaces) of a substrate (e.g., a fabric) comprising:
providing the substrate (e.g., the fabric);
coating (e.g., by spray coating, dip coating, floating knife coating, direct roll coating, padding, calender coating, or foam coating) a portion or all of an exterior surface (e.g., all of the exterior surfaces) of the substrate with a PDMS resin (e.g., a pendant branched PDMS resin or linear PDMS resin) (e.g., a PDMS resin disclosed herein such as, for example, a PDMS resin of any one of Statements 4-13) or a composite nanofluid;
curing (e.g., thermally curing) the PDMS resin coating or coating formed from the composite nanofluid,
   where a layer (e.g., a molecularly rough layer) of the present disclosure (e.g., a layer having a surface tension of less than 22 mJ/m²) is formed on a portion or all of an exterior surface (e.g., all of the exterior surfaces) of the substrate.

Statement 32. A method of forming a layer of the present disclosure disposed on a portion of or all of an exterior surface of a substrate comprising:
coating a portion or all of an exterior surface of the substrate with a poly(dimethylsiloxane) (PDMS) resin or a composite nanofluid; and
curing (e.g., maintaining the coating at a temperature of −30 to 200° C., such as, for example, 20 to 160° C., for example for 1 second to 2 weeks) heating the coating at a temperature of the PDMS resin coating or coating formed from the composite nanofluid, where a layer of the present disclosure is formed on a portion of or all of an exterior surface of the substrate.

Statement 33. The method of any one of Statements 31 or 32, where the PDMS resin comprises:
i) one or more poly(dimethylsiloxane) resin comprising one or more poly(dimethylsiloxane) moieties (e.g., linear or branched poly(dimethylsiloxane) moiet(ies)),
where, optionally, the poly(dimethylsiloxane) resin comprises one or more pendant groups having the following structure:

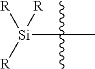

(e.g.,

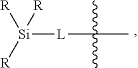

where L is a linking group), where R is independently at each occurrence in the poly(dimethylsiloxane)(s) chosen from alkyl groups and —O—SiOR′ groups, where R′ is independently at each occurrence in the —O—SiOR′ group(s) chosen from alkyl groups (e.g., methyl group); and/or
ii) comprises one or more polymers comprising:
a backbone chosen from linear or branched poly(dimethylsiloxane), hydrocarbon polymer (e.g., polyethylene, polypropylene, polybutylene, and the like), polyacrylate polymer, a poly(methacrylate), poly(styrene), poly(vinylester), poly(allylether), polyester, polyurethane, polyurea, polyamide, polyimide, polysulfone, and combinations thereof, and
   at least one pendant group having the following structure:

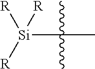

(e.g.,

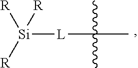

where L is a linking group), where R is independently at each occurrence chosen from alkyl groups and —O—SiOR′ groups, where R′ groups are alkyl groups.

Statement 34. The method of any one of Statements 31-33, where the composite nanofluid comprises a PDMS resin, one or more nanoparticles, and, optionally, a solvent (e.g., toluene, xylenes, hydrocarbons comprising 4 to 16 carbons, such as, for example, hexane), chloroform, tetrahydrofuran and combination thereof).

Statement 35. The method of any one of Statements 31-34, where the substrate is a substrate disclosed herein.

Statement 36. The method of any one of Statements 31-35, where the substrate is a fabric, fiber, filament, glass, ceramic, carbon, metals, wood, polymer, plastic, paper, membrane, concrete, brick, and the like.

Statement 37. The method of any one of Statements 31-36, where the substrate is a fabric has a superhydrophilic layer disposed on all or at least a portion of an exterior surface of the fabric (e.g., the side of the fabric opposite of the side on which the layer of the present disclosure (e.g., layer having a surface tension of less than or equal to 22 mJ/m²) is formed).

Statement 38. The method of any one of Statements 31-37, where the substrate is fluorine-free.

Statement 39. The method of any one of Statements 31-38, where the forming comprises coating (e.g., by dip coating or spray coating) a portion or all of an exterior surface of the substrate with a silica sol (e.g., a silica sol formed by hydrolyzing one or more tetraalkoxysilanes (e.g., in an alcohol/water solution) (e.g., under alkaline conditions) and drying the coated fabric. Examples of tetraalkoxysilanes include tetramethoxysilane, tetraethoxysilane, tetrapropyl orthosilicate, tetrabutyl orthosilicate, and combinations thereof. The silica sol can also be formed by acidifying sodium silicate.

Statement 40. The method of Statement 39, where the coating is spray coating, dip coating, floating knife coating, direct roll coating, padding, calender coating, foam coating, or a combination thereof.

Statement 41. The method of any one of Statements 31-40, further comprising contacting the dried substrate with nanoparticles (e.g., silica nanoparticles, such as, for example, a suspension of silica nanoparticles).

Statement 42. The method of any one of Statements 31-41, further comprising pretreatment of the substrate.

Statement 43. The method of any one of Statements 31-42, comprising forming a layer on all or a portion or all of an exterior surface (e.g., all of the exterior surfaces) of the substrate prior to formation of the layer of the present disclosure (e.g., layer having a surface tension of less than 22 mJ/m²).

Statement 44. The method of any one of Statements 31-43, where the pretreatment is a chemical treatment (e.g., plasma treatment, solvent cleaning, oxidization treatment, hydrolysis treatment, and the like, and combinations thereof), a physical treatment (e.g. sanding treatment and the like), a primer treatment (e.g., with a primer, such as, for example, a sol comprising one or more sol-gel precursors and epoxide primers, comprising one or more acrylate groups, methacrylate groups, allyl groups, vinyl groups, thiol groups, hydroxyl groups, silanol groups, carboxylic acid groups, carboxylate groups, aldehyde groups, amine groups, isocyanate groups, azide groups, epoxy groups, halide groups, hydrogen groups, and the like, and combinations thereof), or a combination thereof.

Statement 45. The method of any one of Statements 31-44, where the pretreatment comprises coating a portion of or all of an exterior surface of the substrate with a non-metal oxide (e.g., silicon oxides and the like), a metal oxide (e.g., aluminum oxides, titanium oxides, iron oxides, copper oxides, and the like, and combinations thereof), or a combination thereof (e.g., a layer comprising non-metal oxide, a metal oxide, or a combination thereof) sol. For example, a coated substrate, such as, for example, a silica sol-coated substrate, comprises one or more functional groups such, for example, acrylate groups, methacrylate groups, allyl groups, vinyl groups, thiol groups, hydroxyl groups, silanol groups, carboxylic acid groups, carboxylate groups, aldehyde groups, amine groups, isocyanate groups, azide groups, alkyne groups, epoxy groups, halide groups, hydrogen groups, and combinations thereof, which may increase the crosslinking density between coated substrate and the layer.

Statement 46. The method of any one of Statements 31-45, where the substrate is cleaned (e.g., plasma cleaned) prior to coating with the silica sol.

Statement 47. The method of any one of Statements 31-46, where the substrate has a plurality of nanoparticles disposed thereon.

Statement 48. The method of any one of Statements 31-47, further comprising contacting the substrate (e.g., which may comprise a dried and/or cured layer) with silica nanoparticles. A portion of or all of the nanoparticles (e.g., silica nanoparticles and the like) may be covalently linked to the substrate, bonded and/or aggregated with other nanoparticles, or a combination thereof. In various examples, a portion of or all of the nanoparticles form reentrant structures.

Statement 49. The method of any one of Statements 31-48, where the coating and curing (e.g., the coating and curing of any of Statements 8-16) are repeated a desired (e.g., 1-20) number of times.

Statement 50. The method of any one of Statements 31-49, further comprising adding additional surface roughness to the layer (e.g., by nanofabrication, electrospinning, forced spinning, extrusion, mechanical stamping, abrasion, etching, or a combination thereof).

Statement 51. A method (e.g., an in situ method) of forming a layer comprising a poly(dimethylsiloxane) (e.g., a layer of the present disclosure) disposed on a portion of or all of an exterior surface of a substrate comprising:
contacting a substrate comprising a plurality of functional groups capable of initiating polymerization of dimethylsiloxane precursors (e.g., comprising one or more

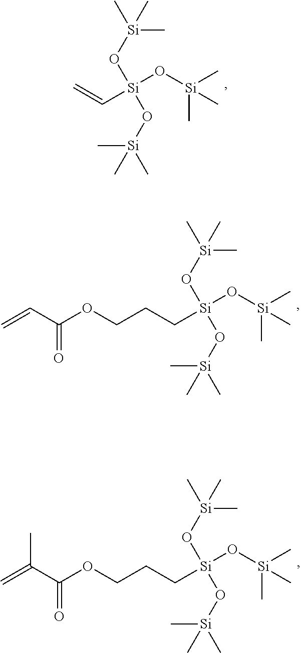

groups, and the like, or a combination thereof, disposed on a surface thereof) with a reaction mixture comprising one or more dimethylsiloxane precursors and
(i) one or more radical initiator (e.g., halide initiators, such as, for example,

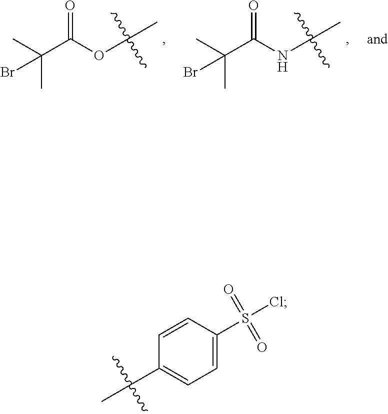

azo radical initiators, such as, for example, azobisisobutyronitrile (AIBN); peroxides, such as, for example, benzoyl peroxide; alkoxyamines, such as, for example, 2,2,6,6-tetramethylpiperidin-1-yl) oxyl; chain transfer agents, such as, for example cyanomethyl [3-(trimethoxysilyl)propyl] trithiocarbonate, and the like, or a combination thereof); or
(ii) one or more activator comprising one or more metal catalyst (e.g., Cu(I), Cu(II), Fe(II), Fe(III), Co(II), and the like, and combinations thereof) and one or more amine (e.g., Diethylenetriamine, triethylenetetramine, N,N-bis(2-pyridylmethyl)amine, tris[2-aminoethyl]amine, 1,4,8,11-tetraazacyclotetradecane, 2,2′-bipyridine, 4,4′-di(5-nonyl)-2,2′-bipyridine, N,N,N′,N′-tetramethylethylenediamine, N-propyl(2-pyridyl)methanimine, 2,2′:6′,2″-terpyridine, 4,4′,4″-tris(5-nonyl)-2,2′:6′,2″-terpyridine, N,N,N′,N″,N″-pentamethyldiethylenetriamine, N,N-bis(2-pyridylmethyl)octylamine, 1,1,4,7,10,10-hexamethyltriethylenetetramine, tris[2-(dimethylamino)ethyl]amine, tris[(2-pyridyl)methyl]amine, 1,4,8,11-tetraaza-1,4,8,11-tetramethylcyclotetradecane, N,N,N′,N′-tetrakis(2-pyridylmethyl)ethylenediamine, and the like, combinations thereof), where a layer comprising a poly(dimethylsiloxane) layer disposed on a surface of the substrate is formed.

Statement 52. The method of Statement 51, where the substrate is a fabric, fiber, filament, glass, ceramic, carbon, metals, wood, polymer, plastic, paper, membrane, concrete, brick, and the like.

Statement 53. The method of any one of Statements 51 or 52, where the substrate has a plurality of nanoparticles disposed thereon.

Statement 54. The method of any one of Statements 51-53, where the substrate is fluorine-free.

Statement 55. The method of any one of Statements 51-54, further comprising pretreatment of the substrate.

Statement 56. The method of any one of Statements 51-55, where the pretreatment is a chemical treatment (e.g., plasma treatment, solvent cleaning, oxidization treatment, hydrolysis treatment, and the like, and combinations thereof), a physical treatment (e.g. sanding treatment and the like), a primer treatment (e.g., with a primer, such as, for example, a sol comprising one or more sol-gel precursors and epoxide primers, comprising one or more acrylate groups, methacrylate groups, allyl groups, vinyl groups, thiol groups, hydroxyl groups, silanol groups, carboxylic acid groups, carboxylate groups, aldehyde groups, amine groups, isocyanate groups, azide groups, alkyne groups, epoxy groups, halide groups, hydrogen groups, and the like, and combinations thereof), or a combination thereof.

Statement 57. The method of any one of Statements 51-56, where the pretreatment comprises coating a portion of or all of an exterior surface of the substrate with a non-metal oxide (e.g., silicon oxides and the like), a metal oxide (e.g., aluminum oxides, titanium oxides, iron oxides, copper oxides, and the like, and combinations thereof), or a combination thereof (e.g., a layer comprising non-metal oxide, a metal oxide, or a combination thereof) sol. For example, a coated substrate, such as, for example, a silica sol-coated substrate, comprises one or more functional groups such, for example, acrylate groups, methacrylate groups, allyl groups, vinyl groups, thiol groups, hydroxyl groups, silanol groups, carboxylic acid groups, carboxylate groups, aldehyde groups, amine groups, isocyanate groups, azide groups, alkyne groups, epoxy groups, halide groups, hydrogen groups, and combinations thereof, which may increase the crosslinking density between coated substrate and the layer.

Statement 58. The method of any one of Statements 51-57, further comprising contacting the substrate, which may comprise a poly(dimethylsiloxane) layer, with silica nanoparticles. A portion of or all of the nanoparticles (e.g., silica nanoparticles and the like) may be covalently linked to the substrate, bonded and/or aggregated with other nanoparticles, or a combination thereof. In various examples, a portion of or all of the nanoparticles form reentrant structures.

Statement 59. The method of any one of Statements 51-58, where the contacting is repeated 1-20 times.

Statement 60. The method of any one of Statements 51-59, further comprising adding additional surface roughness to the layer.

Statement 61. The method of any one of Statements 51-60, where additional surface roughness is added to the layer by nanofabrication, electrospinning, forced spinning, extrusion, mechanical stamping, abrasion, etching, or a combination thereof.

Statement 62. An article of manufacture comprising one or more layer of the present disclosure. For example, one or more layer formed by a method of any one of Statements 31-61.

Statement 63. An article of manufacture comprising one or more fabric comprising a layer (e.g., a molecularly rough layer) of the present disclosure (e.g., a layer having a surface tension of less than 22 mJ/m²) disposed on a portion or all of an exterior surface (e.g., all of the exterior surfaces) of a substrate disclosed herein (e.g., a layer of any one of the Statements 1-30 or a layer made by a method of any one of Statements 31-61).

Statement 64. The article of manufacture of any one of Statements 62 or 63, where the article of manufacture is an article described herein.

Statement 65. The article of manufacture of any one of Statements 62-64, where the article of manufacture is a textile, an article of clothing, food packaging, eye glasses, a display, a scanner, an airplane coating, a sporting good, a building material, a window, a windshield, a corrosion resistant coating, an anti-ice coating, or a cooler (e.g., a condenser for cooling vapors such as for example, water vapors), a light (e.g., a traffic light, a headlight, a lamp, and the like).

The following examples are presented to illustrate the present disclosure. They are not intended to limiting in any matter.

### EXAMPLE 1

This example provides a description of films of the present disclosure.

Approach and Results: We describe fluoro-free oleophobic coatings based on molecularly rough PDMS surfaces. In some formulations the surface roughness is accomplished by the addition of nanoparticles. Surface energies of equal to or less than 18 mN/m were shown, which leads to up to a Grade 3 oleophobic surface based on the AATCC® 118. The coating is robust enough to withstand repeated washing/rinsing cycles (30 cycles) and treatment with various organic solvents (e.g., acetone, ethanol, etc.).

Synthesis of PDMS Resins

Two different PDMS-based resins were synthesized:

Pendant branched PDMS resin (shown schematically in FIG. 2): Tris(trimethylsiloxy)silyl propyl acrylate (10 mmol), vinyltrimethoxysilane (1 mmol) and azobisisobutyronitrile (0.1 mmol) were dissolved in dry xylene (20 mL) at room temperature and purged with N₂ for 5 min. The monomer solution was then heated to 65° C. and maintained at that temperature for 24 h.

Linear PDMS resins (FIG. 3): Amine terminated PDMS (10 mmol), bisphenol A (10 mmol) and paraformaldehyde (40 mmol) were dissolved in 150 mL of chloroform in a 500 mL round-bottom flask. The mixture was heated under reflux for 6 h (hours) to give a clear light yellow solution. After removing the solvent under vacuum, the viscous residue was dissolved in dichloromethane and washed five times with saturated aqueous NaHCO₃ solution and distilled water. A viscous light yellow liquid product was obtained after the washed solution was dried under vacuum.

Pretreatment of Fabric

A 1 cm×1 cm cotton or PET fabric was washed with ethanol and dried in an oven at 80° C. for 10 min. Separately, a silica sol was prepared by alkaline hydrolysis of tetraethoxysilane (10 mmol) in an ethanol/water solution (75 mL, 80% v/v) in the presence of ammonium hydroxide (2.75 mL). The fabric was plasma cleaned and then dipped into the sol for 5 min and dried at room temperature. The process was repeated three times. Finally the fabric was soaked in a suspension of Ludox HS silica (˜5 wt. %) and then dried in an oven at 80° C. overnight.

Fabrication of Fluoro-free Oleophobic Fabric

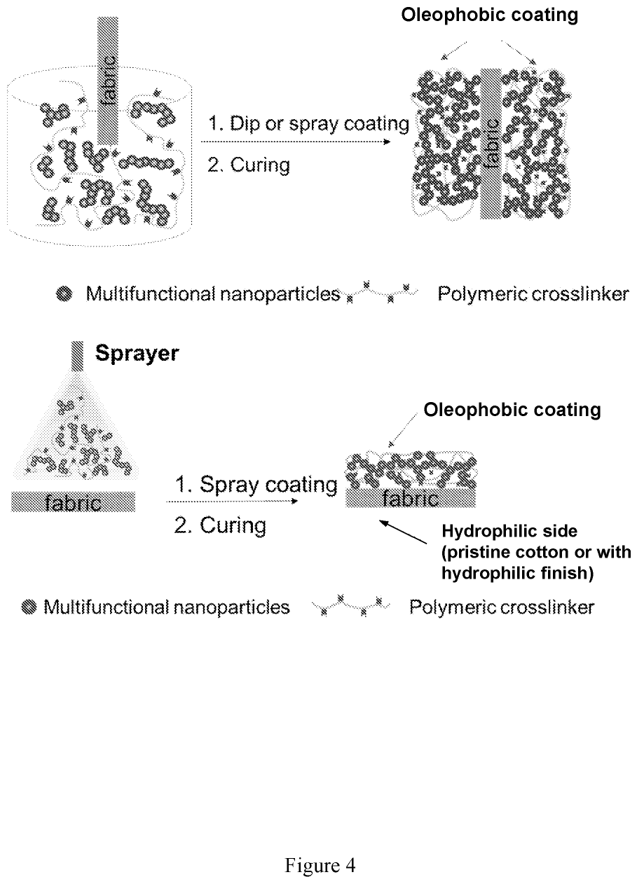

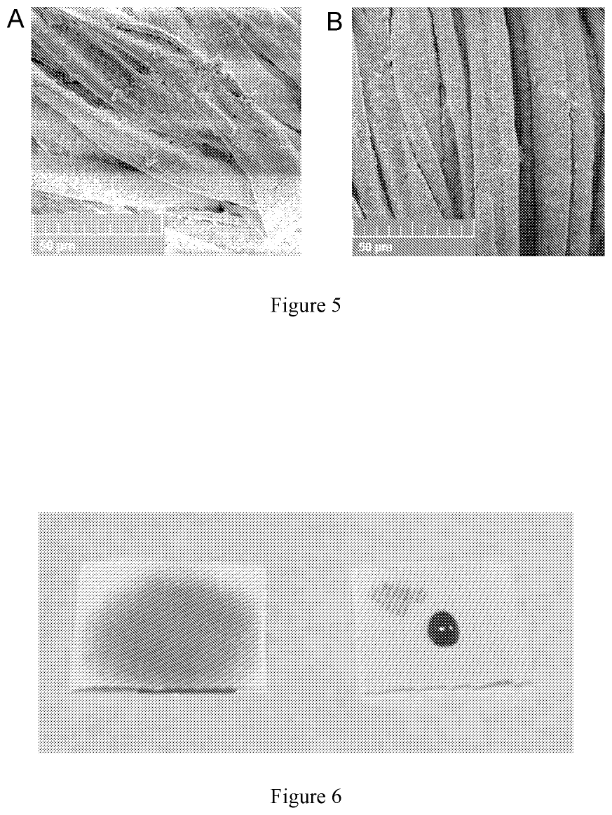

A thin layer of fluoro-free oleophobic coating was applied to the pretreated fabric via dip coating or spray coating (FIG. 4) using the PDMS resin synthesized above at room temperature. The cotton fabric was coated three times and then dried in an oven at 100° C. overnight. The oleophobic PET fabric was prepared in the same manner except that it was cured at 200° C. for 1 h.

### EXAMPLE 2

This example provides a description of films of the present disclosure.

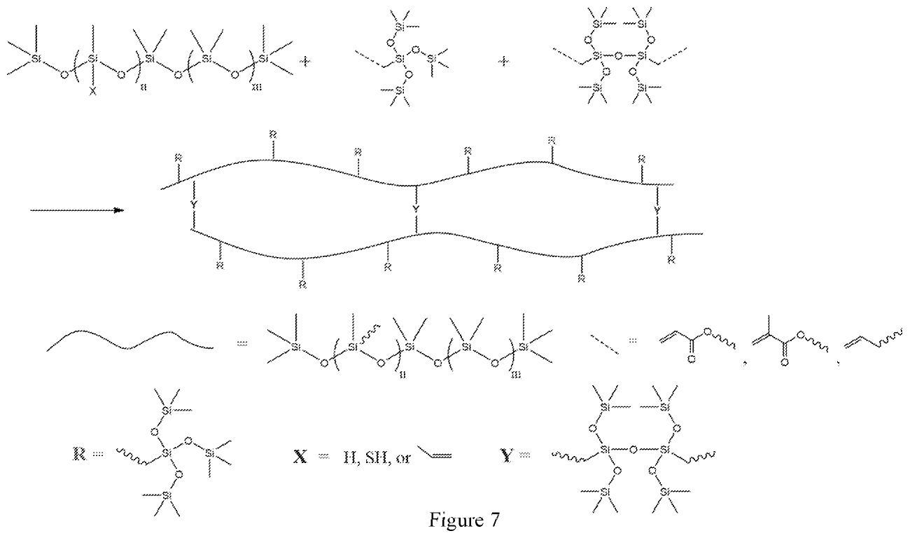

FIG. 7 provides an example of a branched, pendant PDMS resin. The PDMS resin comprises a PDMS polymer with a PDMS backbone. The PDMS polymer can be formed using a multifunctional precursor (e.g., a bifunctional precursor with at least two acrylate groups). The PDMS resin can be colorless.

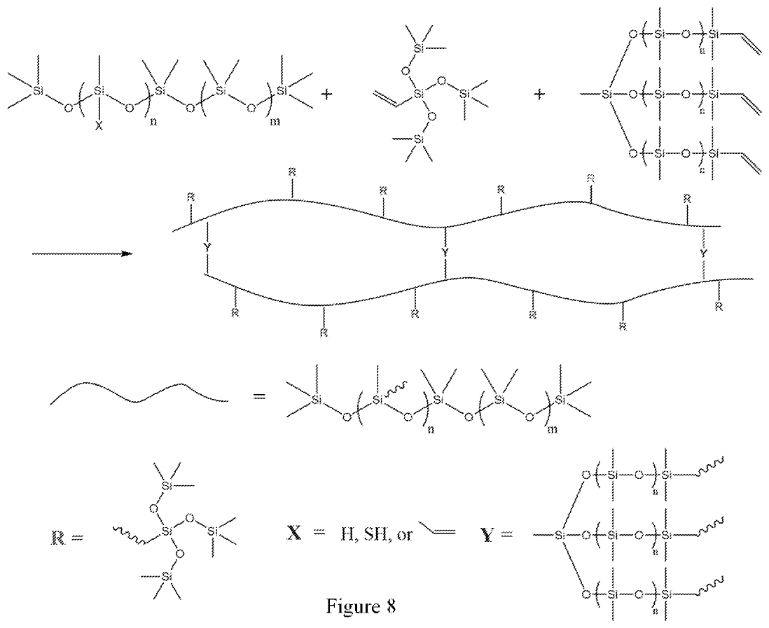

FIG. 8 provides an example of a PDMS resin. The PDMS resin provides an example of a branched, pendant PDMS resin. The PDMS resin comprises a PDMS polymer with a PDMS backbone and PDMS branches. The PDMS polymer can be formed using a multifunctional precursor (e.g., a precursor with at least three vinyl groups).

### EXAMPLE 3

This example provides methods of forming a layer of the present disclosure.

Other than the graft-to methods (e.g., dip coating, spray coating, emulsion/foam coating, etc.), the coating can be applied to the substrates via a graft-from approach (e.g., as shown in FIG. 9). The initiators can be a reversible-deactivation radical generator, such as, for example, a compound comprising one or more organic halide moieties (e.g., alkyl halides), or one or more alkoxyamine moieties, or a suitable chain transfer agent such as, for example, one or more thiocarbonylthio moieties. The monomers can be one or more alkylsilyl compounds comprising one or more aliphatic moieties and/or aliphatic groups. Alkyl halides were effective at initiating polymerization.

Method for oleophobic coating via graft-from atom-transfer radical polymerization (ATRP).

An example for the synthesis: A cleaned fabric sample (˜1.0×1.0 inch) was firstly rinsed with water and acetone and dried in N₂. The dried fabric was soaked in a solution of 2-bromo-2-methylpropionyl bromide (2 mmol), trimethylamine (1 mmol) and catalytic amount of 4-dimethylaminopyridine in 30 mL tetrahydrofuran (THF) at room temperature for 24 h, followed by rinsing with THF and ethanol. The fabric functionalized with ATRP initiator was then soaked in a solution of alkylsilyl monomer, CuBr and N,N′,N″,N″-pentamethyldiethylenetriamine in DMF with a CuBr/PMDETA molar ratio of 0.5-1 for 24 h. The obtained coated fabric was then washed with THF and dried to produce the fabric with the oleophobic coating.

The SEM images of the pristine and oleophobic fabrics are shown in FIG. 10. A uniform coating layer on the surface of the fabrics was observed. Photos of oleophobic fabrics made of different materials can be seen in FIG. 11.

The present disclosure has been shown and described with reference to specific examples, it should be understood by those having skill in the art that various changes in form and detail may be made therein without departing from the spirit and scope of the present disclosure as described herein.

1. A layer comprising one or more PDMS resin, each PDMS resin comprising:
i) one or more poly(dimethylsiloxane), each poly(dimethylsiloxane) comprising one or more poly(dimethylsiloxane) moieties, and
optionally, the poly(dimethylsiloxane)(s) independently comprise one or more pendant groups having the following structure: 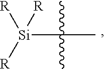
wherein R is independently at each occurrence in the poly(dimethylsiloxane)(s) chosen from alkyl groups and —O—SiOR′ groups, wherein R′ is independently at each occurrence in the —O—SiOR′ group(s) chosen from alkyl groups; and/or
ii) one or more polymers, each polymer comprising:
one or more backbone chosen from a backbone chosen from linear or branched poly(dimethylsiloxane), hydrocarbon polymer, polyacrylate polymer, a poly(methacrylate), poly(styrene), poly(vinylester), poly(allylether), polyester, polyurethane, polyurea, polyamide, polyimide, polysulfone, and combinations thereof, and
optionally, at least one pendant group having the following structure: 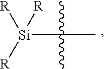
wherein R is independently at each occurrence chosen from alkyl groups and —O—SiOR′ groups, wherein R′ groups are alkyl groups,
wherein the layer is disposed on a portion of or all of an exterior surface of a substrate.

2. The layer of claim 1, wherein the one or more poly(dimethylsiloxane) comprises linear poly(dimethylsiloxane) moiet(ies), branched poly(dimethylsilioxane)s moiet(ies), or a combination thereof.

3. The layer of claim 1, wherein the one or more poly(dimethylsiloxane) is: 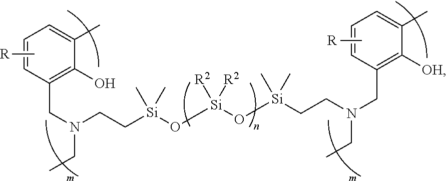
wherein R² is independently at each occurrence chosen from H, hydrocarbon groups having 1 to 40 carbons, or —O—SiOR′ groups, wherein R′ groups are alkyl groups; and n is 0-400 and m is 1-50,000.

4. The layer of claim 1, wherein at least one of the one or more poly(dimethylsiloxane) or linear or branched poly(dimethylsiloxane) has one or more crosslinkable groups.

5. The layer of claim 4, wherein the crosslinkable groups are selected from acrylate, methacrylate, allyl, vinyl, thiol, hydroxyl, silanol, carboxylic acid, aldehyde, amine, isocyanate, azide, alkyne, epoxy, halide, hydrogen, and combinations thereof.

6. The layer of claim 1, the pendant branched PDMS is formed by polymerization of one or more tris(trialkylsiloxy)silyl vinyl compound and trimethoxysilane vinyl compound, wherein the alkyl moieties are independently at each occurrence C₁ to C₄₀ alkyl moieties.

7. The layer of claim 6, wherein the alkyl moieties are independently at each occurrence C₁ to C₃₀, C₁ to C₁₀ alkyl moieties or C₁ to C₅ alkyl moieties.

8. The layer of claim 1, wherein the pendant group is chosen from: 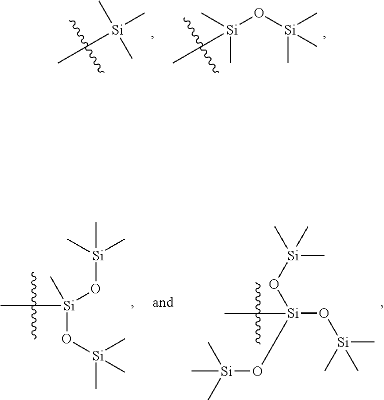
and optionally, the pendant group is covalently bonded to the poly(dimethylsilioxane) resin or backbone by a linking group.

9. The layer of claim 1, wherein the number of R₂OSi repeat units of the one or more poly(dimethylsiloxane) moiet(ies) or the linear or branched poly(dimethylsiloxane)(s) backbone is 0 to 400.

10. The layer of claim 1, wherein the poly(dimethylsiloxane) has the following structure: 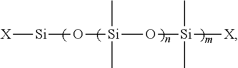
wherein n is 0-600, and m is 0-3, and X is a crosslinkable group including but not limited to the following: acrylate, methacrylate, allyl, vinyl, thiol, hydroxyl, silanol, carboxylic acid, aldehyde, amine, isocyanate, azide, alkyne, epoxy, halide, hydrogen, and combinations thereof.

11. The layer of claim 1, wherein the layer is cured.

12. The layer of claim 1, wherein the layer further comprises at least one crosslink between two polymer chains of a PDMS resin, wherein the two polymer chains of a PDMS resin may be the same or different, and or at least one crosslink between a polymer chain of a PDMS resin, wherein the polymer chains of a PDMS resin may be the same or different, and the substrate.

13. The layer of claim 1, wherein the layer further comprises one or more crosslinking moieties chosen from: 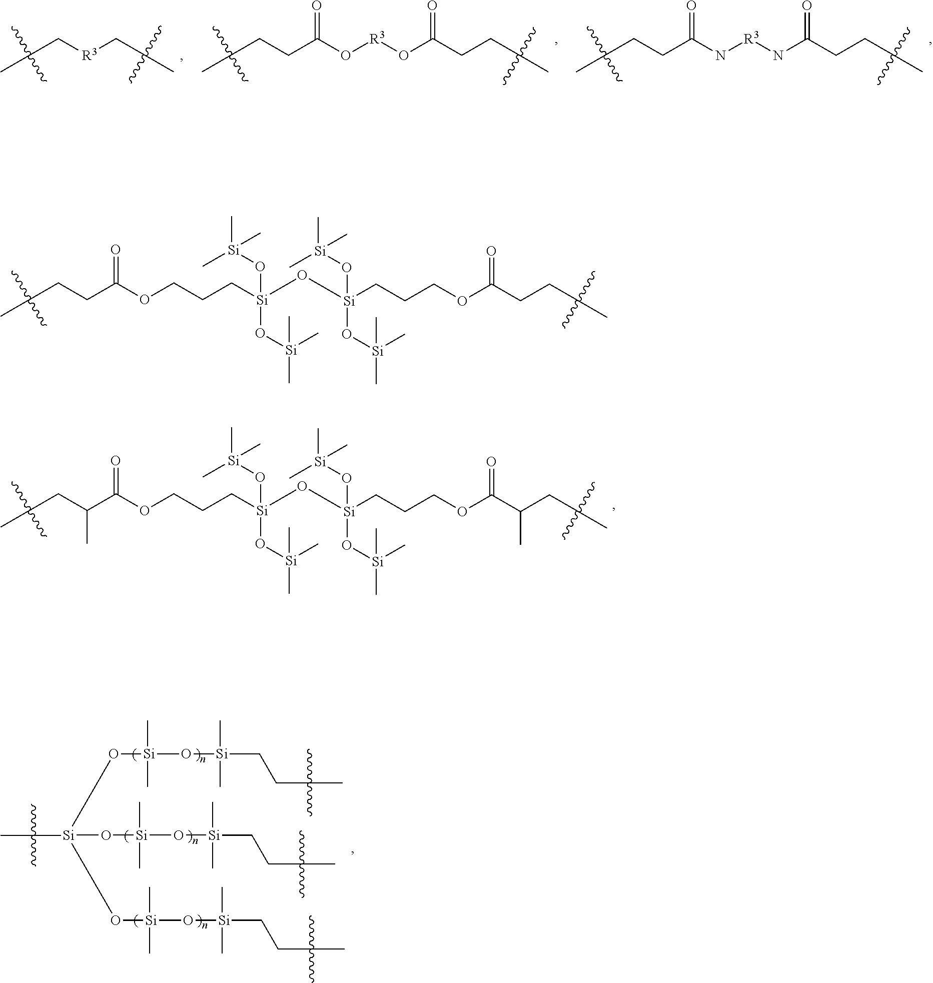
and combinations thereof, wherein R³ is a hydrocarbon group having 1 to 40 and n is 0-600.

14. The layer of claim 1, wherein the layer further comprises a plurality of nanoparticles.

15. The layer of claim 14, wherein the plurality of nanoparticles are selected from the group consisting of silica nanoparticles.

16. The layer of claim 15, wherein the weight percentage of the nanoparticles is 1-98 wt % based on the total weight of the layer.

17. The layer of claim 1, wherein the thickness of the layer is 10 nm-300 microns.

18. The layer of claim 1, wherein the substrate is a fabric, fiber, filament, glass, ceramic, carbon, metals, wood, polymer, plastic, paper, membrane, concrete, brick, and the like.

19. The layer of claim 18, wherein the fabric is chosen from cotton, PET, cotton/PET blends, nylon, polyester, spandex, silk, wool, viscose, cellulose fiber, acrylic, polypropylene, blends thereof, leather, and combinations thereof.

20. The layer of claim 1, wherein the substrate is a fabric having a superhydrophilic layer disposed on a portion of an exterior surface of the fabric.

21. The layer of claim 1, wherein the layer exhibits a surface tension of less than or equal to 22 mJ/m².

22. The layer of claim 1, wherein the layer having a surface tension of less than or equal to 22 mJ/m² and superhydrophilic layer are disposed on opposite sides of a fabric.

23. The layer of claim 1, wherein the substrate and/or layer is fluorine-free.

24. A method of forming a layer of claim 1 disposed on a portion of or all of an exterior surface of a substrate comprising:
coating a portion or all of an exterior surface of the substrate with a poly(dimethylsiloxane) (PDMS) resin or a composite nanofluid; and
curing and heating the coating at a temperature of the PDMS resin coating or coating formed from the composite nanofluid,
wherein a layer of claim 1 is formed on a portion of or all of an exterior surface of the substrate.

25. The method of claim 24, wherein the PDMS resin comprises:
i) one or more poly(dimethylsiloxane) resin comprising one or more poly(dimethylsiloxane) moieties,
wherein, optionally, the poly(dimethylsiloxane) resin comprises one or more pendant groups having the following structure: 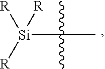
wherein R is independently at each occurrence in the poly(dimethylsiloxane)(s) chosen from alkyl groups and —O—SiOR′ groups, wherein R′ is independently at each occurrence in the —O—SiOR′ group(s) chosen from alkyl groups; and/or
ii) comprises one or more polymers comprising:
a backbone chosen from linear or branched poly(dimethylsiloxane), hydrocarbon polymer, polyacrylate polymer, a poly(methacrylate), poly(styrene), poly(vinylester), poly(allylether), polyester, polyurethane, polyurea, polyamide, polyimide, polysulfone, and combinations thereof, and
at least one pendant group having the following structure: 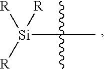
wherein R is independently at each occurrence chosen from alkyl groups and —O—SiOR′ groups, wherein R′ groups are alkyl groups.

26. The method of claim 24, wherein the composite nanofluid comprises a PDMS resin, one or more nanoparticles, and, optionally, a solvent, chloroform, tetrahydrofuran and combination thereof).

27. The method of claim 24, wherein the substrate is a fabric, fiber, filament, glass, ceramic, carbon, metals, wood, polymer, plastic, paper, membrane, concrete, brick, and the like.

28. The method of claim 24, wherein the substrate has a plurality of nanoparticles disposed thereon.

29. The method of claim 24, wherein the substrate is fluorine-free.

30. The method of claim 24, wherein the coating is spray coating, dip coating, floating knife coating, direct roll coating, padding, calender coating, foam coating, or a combination thereof.

31. The method of claim 24, further comprising pretreatment of the substrate.

32. The method of claim 31, wherein the pretreatment is a chemical treatment, a physical treatment, a primer treatment, or a combination thereof.

33. The method of claim 31, wherein the pretreatment comprises coating a portion of or all of an exterior surface of the substrate with a non-metal oxide, a metal oxide, or a combination thereof.

34. The method of claim 24, further comprising contacting the substrate with silica nanoparticles.

35. The method of claim 24, wherein the coating and curing are repeated 1-20 times.

36. The method of claim 24, further comprising adding additional surface roughness to the layer.

37. The method of claim 36, wherein additional surface roughness is added to the layer by nanofabrication, electrospinning, forced spinning, extrusion, mechanical stamping, abrasion, etching, or a combination thereof.

38. A method of forming a layer comprising a poly(dimethylsiloxane) disposed on a portion of or all of an exterior surface of a substrate comprising:
contacting a substrate comprising a plurality of functional groups capable of initiating polymerization of dimethylsiloxane precursors with a reaction mixture comprising one or more dimethylsiloxane precursors and
(i) one or more radical initiator; or
(ii) one or more activator comprising one or more metal catalyst and one or more amine,
wherein a layer comprising a poly(dimethylsiloxane) layer disposed on a surface of the substrate is formed.

39. The method of claim 38, wherein the substrate is a fabric, fiber, filament, glass, ceramic, carbon, metals, wood, polymer, plastic, paper, membrane, concrete, brick, and the like.

40. The method of claim 38, wherein the substrate has a plurality of nanoparticles disposed thereon.

41. The method of claim 38, wherein the substrate is fluorine-free.

42. The method of claim 38, further comprising pretreatment of the substrate.

43. The method of claim 42, wherein the pretreatment is a chemical treatment, a physical treatment, a primer treatment, or a combination thereof.

44. The method of claim 42, wherein the pretreatment comprises coating a portion of or all of an exterior surface of the substrate with a non-metal oxide, a metal oxide, or a combination thereof.

45. The method of claim 38, further comprising contacting the substrate, which may comprise a poly(dimethylsiloxane) layer, with silica nanoparticles

46. The method of claim 38, wherein the contacting is repeated 1-20 times.

47. The method of claim 38, further comprising adding additional surface roughness to the layer.

48. The method of claim 47, wherein additional surface roughness is added to the layer by nanofabrication, electrospinning, forced spinning, extrusion, mechanical stamping, abrasion, etching, or a combination thereof.

49. An article of manufacture comprising one or more layer of claim 1.

50. The article of manufacture of claim 49, wherein the article of manufacture is a textile, an article of clothing, food packaging, eye glasses, a display, a scanner, an airplane coating, a sporting good, a building material, a window, a windshield, a corrosion resistant coating, an anti-ice coating, a cooler, or a light.
